(19) United States
(12) Patent Application Publication
(10) Pub. No.: US 2015/0109762 A1
(43) Pub. Date: Apr. 23, 2015

(54) MEMBER FOR COTROLLING LUMINOUS FLUX, DISPLAY DEVICE, AND LIGHT EMITTING DEVICE

(71) Applicant: LG INNOTEK CO., LTD., Seoul (KR)

(72) Inventors: Gi Seok Lee, Seoul (KR); Eun Sung Seo, Seoul (KR); Hyun Ho Choi, Seoul (KR); Chang Hyuck Lee, Seoul (KR); Ki Cheol Kim, Seoul (KR); Lee Im Kang, Seoul (KR)

(21) Appl. No.: 14/404,520

(22) PCT Filed: Dec. 14, 2012
(86) PCT No.: PCT/KR2012/010940

§ 371 Date: Nov. 28, 2014

(30) Foreign Application Priority Data
May 31, 2012 (KR) 10-2012-0058862
Aug. 16, 2012 (KR) 10-2012-0089622

(51) Int. Cl. F21V 7/00; F21V 13/04

(52) U.S. Cl. CPC F21V 7/00; F21V 13/04
USPC 362/97.1; 362/341; 362/329; 362/296.01

(57) ABSTRACT

The present invention relates to a member for controlling luminous flux including an incident surface receiving light, a reflective surface reflecting the incident light, and a light emitting surface emitting the reflected light to a bottom surface of a plane perpendicular to a central axis connecting a center of the incident surface and a center of the reflective surface, and to a display device and a light emitting device, whereby performance of display device can be enhanced.

### TECHNICAL FIELD

The teachings in accordance with exemplary and non-limiting embodiments of this invention relate generally to a member for controlling luminous flux, display device and light emitting device.

### BACKGROUND ART

Generally, due to the characteristics of light weight, slim thickness, low electric power consumption, the liquid crystal display device (or, LCD) is being widely applied. The LCD displays a picture data (or an image) by using the physical property of crystal that changes array in response to voltage or temperature.

The LCD includes a backlight unit (BLU) and a liquid crystal display panel. As LCD is not a self-luminescent element, the LCD requires a backlight unit for irradiating light to the liquid crystal display panel. At this time, the backlight unit is mounted with a light source for substantially generating light, and classified into two kinds depending on where the light source is positioned.

That is, there are two kinds of the backlight units for LCD, one is the direct type backlight unit and the other is the edge type backlight system. For the edge type backlight unit, light source such as a fluorescent light source is equipped at the circumferences of the transparent light guide panel. The light radiated from the fluorescent light source to the side surface of the light guide panel is refracted and/or reflected to the front side on which an LCD panel is disposed. On the other hands, for the direct type backlight unit, a plurality of fluorescent light sources are disposed under the back side of the LCD panel so that the light is directly radiated from the light source to the overall surface of the LCD panel.

However, the abovementioned backlight units, in radiating light, suffer from disadvantages in that a yellow ring at an edge of light appears in the liquid crystal display panel. The yellow ring is generated by a difference of moving paths caused by wavelengths of light radiated from the backlight unit. That is, a moving path of yellow color is longer than moving paths of other colors to generate a color deflection on the liquid crystal display device, whereby an inconsistent of color distribution is generated by the liquid crystal display device. As a result, performance of the liquid crystal display device may be degraded.

### DISCLOSURE

### Technical Problem

Accordingly, the present invention has been made keeping in mind the above disadvantages/problems occurring in the prior art, and therefore, exemplary embodiments of this invention are to provide a display device having a uniform color (shade) distribution. That is, the present invention is to prevent a yellow ring from being generated from a display device. Furthermore, the present invention is to enhance performances of a display device.

Still furthermore, exemplary embodiments of this invention are to provide a member for controlling luminous flux having enhanced brightness uniformity and configured to be easily manufactured, and a display device.

### Technical Solution

In order to accomplish the above object, the present invention provides a member for controlling luminous flux (hereinafter referred to as “luminous flux control member”), the member comprising: an incident surface receiving light; a reflective surface reflecting the incident light; and a light emitting surface emitting the reflected light to a bottom surface of a plane perpendicular to a central axis connecting a center of the incident surface and a center of the reflective surface.

Preferably, but not necessarily, a first direction may be defined as being perpendicular to the central axis, and a second direction may be defined as being perpendicular to the central axis and crossing the first direction, and a first length based on the first direction may be shorter than a second length based on the second direction.

Preferably, but not necessarily, the first and second directions may be orthogonal.

Preferably, but not necessarily, the reflective surface may be an inner surface of a depression unit formed opposite to the incident surface.

Preferably, but not necessarily, the depression unit may be configured such that a third length based on the first direction is shorter than a fourth length based on the second direction.

In another general aspect of the present invention, there is provided a member for controlling luminous flux (hereinafter referred to as “luminous flux control member”), the member comprising: an incident surface receiving light; and a refractive surface emitting the light from the incident surface, wherein a central axis is defined as being extended from a center of the incident surface to a center of the refractive surface, a first direction is defined as passing the central axis, being perpendicular to the central axis, and crossing the first direction, and a second direction is defined as passing the central axis, being perpendicular to the central axis and orthogonal to the first direction, wherein a shape of the refractive surface based on the first direction is different from a shape of the refractive surface based on the second direction.

Preferably, but not necessarily, the first direction may be orthogonal to the second direction.

Preferably, but not necessarily, the luminous flux control member may include a rear surface extended from the incident surface to the refractive surface, and a first distance from the central axis to a portion where the refractive surface and the rear surface meet based on the first direction is shorter than a second distance from the central axis to a portion where the refractive surface and the rear surface meet based on the second direction.

Preferably, but not necessarily, the luminous flux control member may satisfy the following Equations 1 and 2:

θ5x/θ1x=ax>1 [Equation 1]

θ5y/θ1y=ay>1 [Equation 2]

where, θ1x is an angle formed between an arbitrary light incident through the incident surface and the central axis based on the first direction, θ5x is an angle formed between light emitted through a light emitting surface and the central axis, in a case light incident at the angle of θ1x is emitted through the light emitting surface based on the first direction, θ1y is an angle formed between an arbitrary light incident through the incident surface and the central axis based on the second direction, and θ5y is an angle formed between light emitted through the light emitting surface and the central axis, in a case light incident at the angle of θ1y is emitted through the light emitting surface based on the second direction, where ax is different from ay.

Preferably, but not necessarily, ax may decrease, in a case θ1x increases, and ay may decrease, in a case θ1y increases.

Preferably, but not necessarily, the luminous flux control member may include a rear surface extended from the incident surface to the refractive surface, the refractive surface may include a first refractive surface extended from the rear surface, and a distance between the first refractive surface and the central axis may taper off as being distanced from the rear surface based on the first direction.

Preferably, but not necessarily, the luminous flux control member may further comprise a depression unit opposite to the incident surface.

In still another general aspect of the present invention, there is provided a light emitting device, the device comprising: a driving substrate; a light source arranged on the driving substrate; a luminous flux control member arranged on the light source and including an incident surface incident with light generated from the light source, a reflective surface reflecting the incident light, and a light emitting surface emitting the reflected light to a bottom surface of a plane perpendicular to a central axis connecting a center of the incident surface to a center of the reflective surface.

Preferably, but not necessarily, the light emitting device may further comprise a reflective unit arranged on the driving substrate for reflecting the emitted light.

Preferably, but not necessarily, the reflective unit may reflect the emitted light in a lambertian type.

Preferably, but not necessarily, the luminous flux control member may be such that a first direction perpendicular to the central axis, and a second direction perpendicular to the central axis and crossing the first direction are defined, and a first length based on the first direction is shorter than a second length based on the second direction.

Preferably, but not necessarily, the luminous flux control member may emit the reflected light to a bottom surface of the plane based on the first direction.

Preferably, but not necessarily, the reflective unit may be distanced from the luminous flux control member to the first direction, and extended to the second direction.

In still further general aspect of the present invention, there is provided a display device, the device comprising: a driving substrate; a light source arranged on the driving substrate; a luminous flux control member arranged on the light source and including an incident surface incident with light generated from the light source, a reflective surface reflecting the incident light, and a light emitting surface emitting the reflected light to a bottom surface of a plane perpendicular to a central axis connecting a center of the incident surface to a center of the reflective surface; and a display panel incident with the emitted light.

Preferably, but not necessarily, the display device may further comprise; a cover accommodating the driving substrate; and a reflective unit arranged on any one of the driving substrate and the cover to reflect the emitted light.

Preferably, but not necessarily, the reflective unit may reflect the emitted light in a lambertian type.

Preferably, but not necessarily, the luminous flux control member may be such that a first direction perpendicular to the central axis, and a second direction perpendicular to the central axis and crossing the first direction are defined, and a first length based on the first direction is shorter than a second length based on the second direction.

Preferably, but not necessarily, the luminous flux control member may emit the reflected light to a bottom surface of the plane based on the first direction.

Preferably, but not necessarily, the reflective unit may be distanced from the luminous flux control member to the first direction, and extended to the second direction.

In still further general aspect of the present invention, there is provided a display device, the device comprising: a driving substrate extended to a second direction; a light source arranged on the driving substrate; a luminous flux control member arranged on the driving substrate to cover the light source; and a display panel incident with light from the luminous flux control member, wherein the luminous flux control member includes a refractive surface emitting the light from the light source, and the luminous flux control member is such that a first direction is defined as passing an OA (Optical Axis) of the light source, being perpendicular to the OA, and orthogonal to a second direction, wherein a shape of the refractive surface based on the first direction is different from a shape of the refractive surface based on the second direction.

Preferably, but not necessarily, the luminous flux control member may satisfy the following Equations 1 and 2:

θ5x/θ1x=ax>1 [Equation 1]

θ5y/θ1y=ay>1 [Equation 2]

where, θ1x is an angle formed between an arbitrary light incident through the incident surface and the central axis based on the first direction, θ5x is an angle formed between light emitted through a light emitting surface and the central axis, in a case light incident at the angle of θ1x is emitted through the light emitting surface based on the first direction, θ1y is an angle formed between an arbitrary light incident through the incident surface and the central axis based on the second direction, and θ5y is an angle formed between light emitted through the light emitting surface and the central axis, in a case light incident at the angle of θ1y is emitted through the light emitting surface based on the second direction, where ax is different from ay.

Preferably, but not necessarily, the light incident from the light source and emitted through the refractive surface may have a first beam angle based on the first direction, and may have a second beam angle based on the second direction, wherein the first beam angle is greater than the second beam angle.

### Advantageous Effects

The member for controlling luminous flux (hereinafter referred to as “luminous flux control member”), the display device and the light emitting device according to exemplary embodiments of the present invention are such that the luminous flux control member can expand coverage of light wavelength in a display panel by emitting, by the luminous flux control member, light to a bottom surface of a plane perpendicular to an OA of the light source, whereby the coverage of the light wavelengths can be overlapped at the display panel. As a result, the display device can have a uniform color distribution. In addition, an optical diffusion range at the display device can be expanded to enhance brightness uniformity of the display device, through which performance of the display device can be improved.

Furthermore, the display device according to exemplary embodiments of the present invention can differently form a shape of a refractive surface of the luminous flux control member depending on a first direction and a second direction. As a result, the luminous flux control member can differently control light velocity depending on the first direction and the second direction. That is, the luminous flux control member can emit incident light not symmetrically relative to the optical axis, but symmetrically relative to a surface passing an optical axis.

Particularly, light emitted from the light source can be more diffused to a first direction perpendicular to a second direction than to the second direction. At this time, the light sources are arranged in a row to a direction substantially parallel to the second direction. Furthermore, the light sources are densely arranged to the second direction and are less densely arranged to the first direction. As a result, the light emitted from the luminous flux control member can be incident on the display panel with a uniform brightness on the whole.

That is, the display device according to exemplary embodiments of the present invention can have high brightness uniformity on the whole by the luminous flux control member, even if the number of arranged rows of the light sources decreases. In other words, even if a gap between rows of the light sources increases, the brightness uniformity to the second direction can be enhanced by the luminous flux control member. As a result, the display device according to exemplary embodiments of the present invention can reduce the number of rows of light sources and reduce the number of used circuit boards, whereby the display device according to exemplary embodiments of the present invention can be easily manufactured with reduced costs.

### DESCRIPTION OF DRAWINGS

The teachings of the present invention can be readily understood by considering the following Detailed Description in conjunction with the accompanying drawings, in which:

FIG. 1 is an exploded perspective view illustrating a light emitting device according to a first exemplary embodiment of the present invention;

FIG. 2 is a cross-sectional view illustrating a cross-section of a light emitting device based on a first direction according to a first exemplary embodiment of the present invention;

FIG. 3 is a cross-sectional view illustrating a cross-section of a light emitting device based on a second direction according to a first exemplary embodiment of the present invention;

FIG. 4 is a cross-sectional view illustrating a beam angle based on a first direction of a luminous flux control member in a light emitting device according to a first exemplary embodiment of the present invention;

FIG. 5 is an exploded perspective view illustrating a light emitting device according to a second exemplary embodiment of the present invention;

FIG. 6 is a cross-sectional view illustrating a cross-section based on a first direction of a light emitting device according to a second exemplary embodiment of the present invention;

FIG. 7 is a cross-sectional view illustrating a cross-section based on a second direction of a light emitting device according to a second exemplary embodiment of the present invention;

FIG. 8 is an exploded perspective view illustrating a light emitting device according to a third exemplary embodiment of the present invention;

FIG. 8 is a cross-sectional view illustrating a cross-section of a light emitting device according to an exemplary embodiment of the present invention;

FIG. 9 is a cross-sectional view illustrating a cross-section based on a first direction of a light emitting device according to a third exemplary embodiment of the present invention;

FIG. 10 is a cross-sectional view illustrating a cross-section based on a second direction of a light emitting device according to a third exemplary embodiment of the present invention;

FIG. 11 is an exploded perspective view illustrating a light emitting device according to a fourth exemplary embodiment of the present invention;

FIG. 12 is a cross-sectional view illustrating a cross-section based on a first direction of a light emitting device according to a fourth exemplary embodiment of the present invention;

FIG. 13 is a cross-sectional view illustrating a cross-section based on a second direction of a light emitting device according to a fourth exemplary embodiment of the present invention;

FIG. 14 is an exploded perspective view illustrating a display device according to an exemplary embodiment of the present invention;

FIG. 15 is a cross-sectional view illustrating a cross-section cut along line A-A′ of FIG. 14;

FIG. 16 is an exploded perspective view illustrating a display device according to a fifth exemplary embodiment of the present invention;

FIG. 17 is a cross-sectional view illustrating a cross-section based on a first direction of a light emitting device according to a fifth exemplary embodiment of the present invention;

FIG. 18 is a cross-sectional view illustrating a cross-section based on a second direction of a light emitting device according to a fifth exemplary embodiment of the present invention;

FIGS. 19 and 20 are schematic views illustrating a process of forming a luminous flux control member;

FIG. 21 is an exploded perspective view illustrating a liquid crystal display device according to a fifth exemplary embodiment of the present invention;

FIG. 22 is a cross-sectional view illustrating a cross-section cut along line A-A′ of FIG. 21;

FIG. 23 is a schematic view illustrating an optical path of light emitted from a luminous flux control member based on a first direction; and

FIG. 24 is a schematic view illustrating an optical path of light emitted from a luminous flux control member based on a second direction.

### BEST MODE

Hereinafter, exemplary embodiments will be described in detail with reference to the accompanying drawings, wherein the same reference numerals are used to denote the same or substantially the same devices throughout the specification and the drawings. Accordingly, in some embodiments, well-known processes, well-known device structures and well-known techniques are not illustrated in detail to avoid unclear interpretation of the present invention.

In the drawings, it will be understood that when a panel (a sheet, a member, a guide or a unit) is referred to as being ‘on’ or ‘under’ another panel (another sheet, another member, another guide or another unit), it can be directly on or under the other panel (sheet, member, guide or unit), or intervening panels (sheets, members, guides or units) may also be present. In the drawings, the dimensions, such as sizes or thicknesses, of layers or films are exaggerated, omitted, or schematically shown for clarity of illustration. Accordingly, the sizes of the devices in the drawings do not thoroughly reflect real sizes of devices. Furthermore, the term of ‘surface’ and ‘plane’ may be interchangeably used.

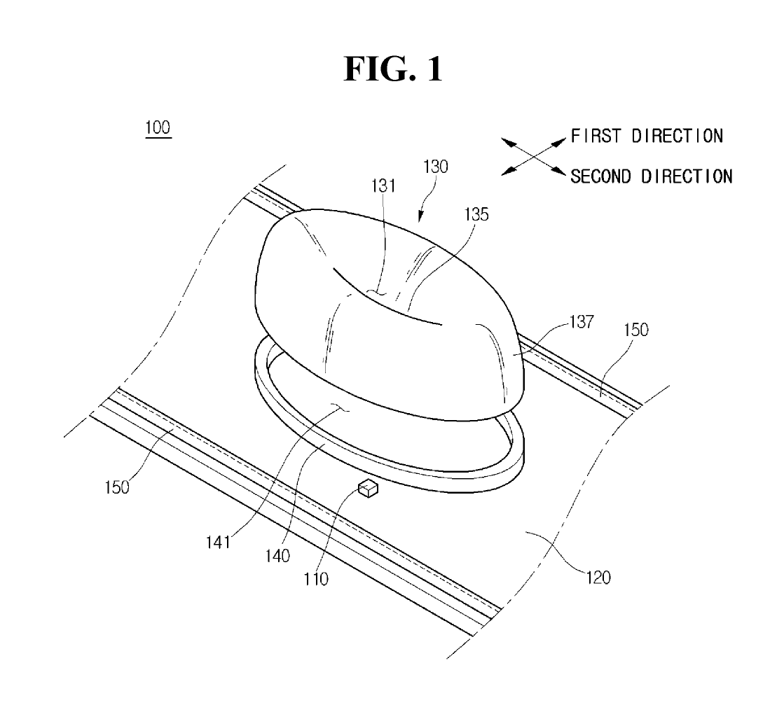

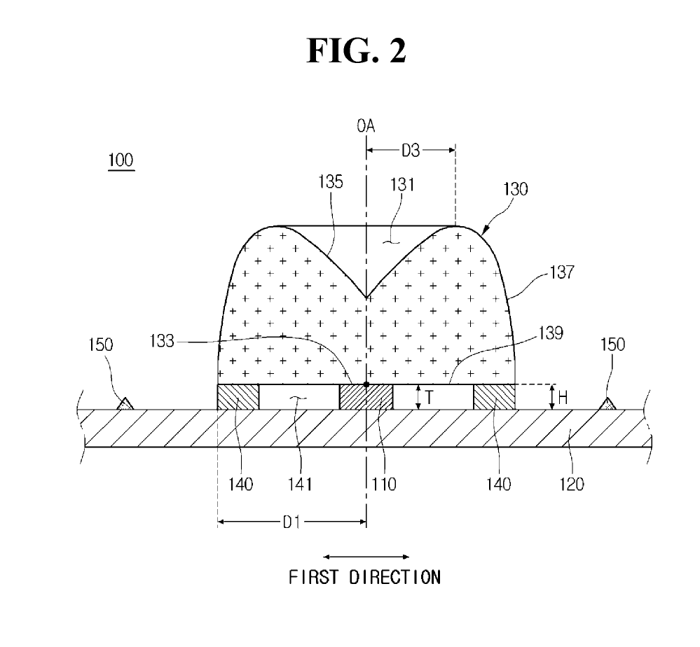

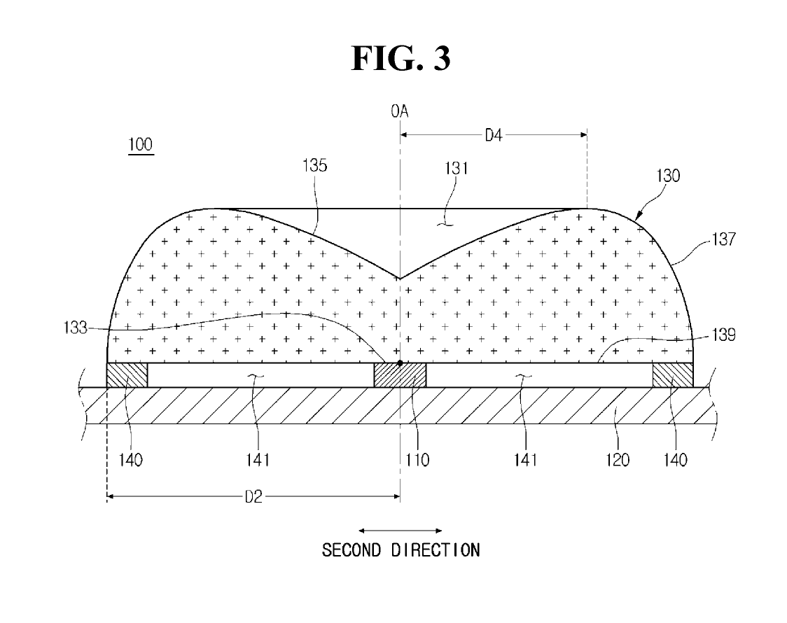

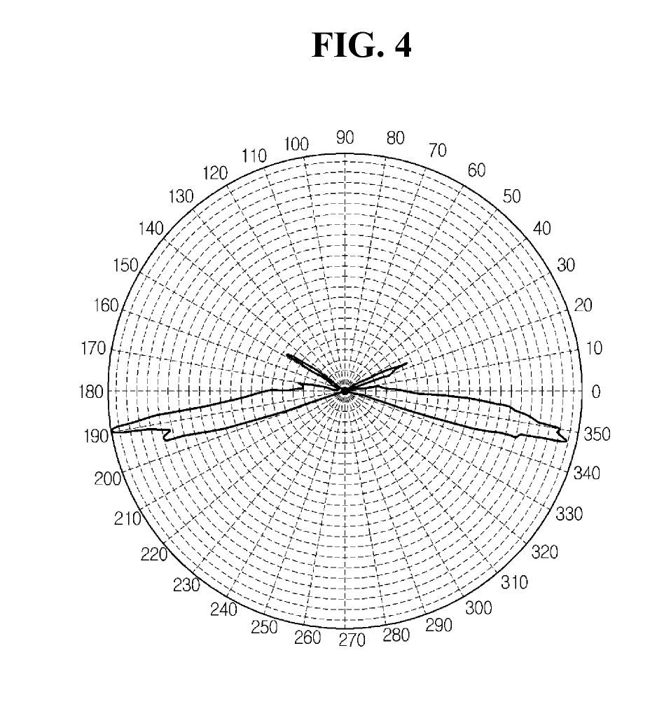

FIG. 1 is an exploded perspective view illustrating a light emitting device according to a first exemplary embodiment of the present invention, FIG. 2 is a cross-sectional view illustrating a cross-section of a light emitting device based on a first direction according to a first exemplary embodiment of the present invention, FIG. 3 is a cross-sectional view illustrating a cross-section of a light emitting device based on a second direction according to a first exemplary embodiment of the present invention, and FIG. 4 is a cross-sectional view illustrating a beam angle based on a first direction of a luminous flux control member in a light emitting device according to a first exemplary embodiment of the present invention.

Referring to FIGS. 1, 2 and 3, a light emitting device (100) according to an exemplary embodiment of the present invention includes a light source (110), a driving substrate (120), a member for controlling luminous flux (hereinafter referred to as a luminous flux control member, 130), a support member (140) and a reflective unit (150).

The light source (110) generates light. The light source (110) is mounted on the driving substrate (120). The light source (110) generates light in response to a driving signal received by the driving substrate (130), where the light source (110) may adjust a light amount (luminous energy) in response to intensity of voltage applied from the driving substrate (130).

At this time, the light source (110) may be a point light source such as an LED (Light Emitting Diode). Furthermore, the light source (110) may be a surface light source formed by arranging a plurality of LEDs. That is, the light source (110) may be realized by a structure in which a plurality of LEDs is dispersed and arranged on the driving substrate (130) each spaced apart at a predetermined distance. At this time, each of the LEDs is defined by a light emitting diode package including a light emitting diode chip. Furthermore, the LEDs may evenly emit white light, and may emit a blue light, a green light and a red light respectively.

The driving substrate (120) supports the light source (110) and controls the driving of the light source (110). Furthermore, the driving substrate (120) is electrically connected to the light source (110). The driving substrate (120) transmits a driving signal to the light source (110), where the driving substrate (120) may be a PCB (Printed Circuit Board). By way of non-limiting example, the driving substrate (120) may have a flat structure. The driving substrate (120) may be embedded with a plurality of transmission lines (not shown). At this time, one distal end of the transmission line may be connected to a driving unit (not shown). In addition, the other distal end of the transmission line may be exposed to outside to form a connection terminal (not shown). At this time, the light source (110) is adhered to the connection terminal using a paste to allow the driving substrate (120) to be electrically connected to the light source (110).

The luminous flux control member (130) serves to control a light velocity of light generated by the light source (110). That is, the luminous flux control member (130) functions to diffuse the light generated by the light source (110). At this time, the luminous flux control member (130) may emit light, based on a beam angle as shown in FIG. 4. That is, the luminous flux control member (130) may emit the light to a bottom surface of a plane perpendicular to an OA (Optical Axis) of the light source (110). At this time, the beam angle of the luminous flux control member (130) may be more than 150° or more, or may be less than 260°.

The luminous flux control member (130) is mounted on the driving substrate (120). At this time, the luminous flux control member (130) is mounted on the driving substrate (120) via the support member (140). Furthermore, the luminous flux control member (130) is arranged on the light source (110). The OA of the light source (110) passes a center of the flux control member (130). Furthermore, the luminous flux control member (130) covers the OA of the light source (110).

At this time, the luminous flux control member (130) has an anisotropic structure. That is, the luminous flux control member (130) has a planar symmetrical structure instead of axial symmetrical structure. Furthermore, the luminous flux control member (130) is relatively shorter to a first direction and relatively longer to a second direction. That is, a first length (D1) based on the first direction is shorter than a second length (D2) based on the second direction in the luminous flux control member (130). Each of the first and second directions is perpendicular to the OA of the light source (110). Furthermore, the first direction crosses the second direction. At this time, the first direction is orthogonal to the second direction. In addition, a shape of a plane of the luminous flux control member (130) may be oval, for example.

At this time, a first symmetrical surface and a second symmetrical surface are defined. The first symmetrical surface is a plane extended to the first direction from the OA of the light source (110). The second symmetrical surface is a plane extended to the second direction from the OA of the light source (110). That is, the OA of the light source (110) is arranged on the first symmetrical surface and the second symmetrical surface. Furthermore, the first symmetrical surface and the second symmetrical surface cross at the OA of the light source (110).

That is, a first area of the first symmetrical surface is smaller than a second area of the second symmetrical surface in the luminous flux control member (130). Furthermore, the luminous flux control member (130) has an axial symmetrical structure relative to the first symmetrical surface and the second symmetrical surface respectively. That is, the luminous flux control member (130) may be bisected with an equal size by the first symmetrical surface. Furthermore, the luminous flux control member (130) may be bisected with an equal size by the second symmetrical surface.

The luminous flux control member (130) is formed with a transparent material. A refractive index of the luminous flux control member (130) may be approximately 1.4 to 1.5. The luminous flux control member (130) may be formed with a transparent resin. To be more specific, the luminous flux control member (130) may include

a thermoplastic resin. At this time, the luminous flux control member (130) may include silicon resin. By way of non-limiting example, the luminous flux control member (130) may be formed with PDMS (Polydimethylsiloxane) or PMMA (Polymethylmethacrylate).

The luminous flux control member (130) may be formed with a depression (dent) unit (131). The luminous flux control member (130) includes an incident surface (133), a reflective surface (135), a light emitting surface (137) and a rear surface (139).

The depression (dent) unit (131) is formed at an upper surface of the luminous flux control member (130). The depression (dent) unit (131) is formed opposite to the light source (110). At this time, the depression (dent) unit (131) may be concavely formed toward the light source (110). The depression (dent) unit (131) is formed at a center portion of the luminous flux control member (130). At this time, a center of the depression unit (131) is arranged on the OA of the light source (110). At this time, a third length (D3) based on the first direction is shorter than a fourth length (D4) based on the second direction in the depression unit (131). In addition, a plane shape of the depression unit (131) may be oval, for example.

The incident surface (133) is a plane incident with light generated by the light source (110). The incident surface (133) is formed opposite to the light source (110). At this time, a center of the incident surface (133) is arranged on the OA of the light source (110). At this time, the incident surface (133) may be tightly brought into contact with the light source (110). That is, the incident surface (133) may be directly brought into contact with the light source (110). Alternatively, the incident surface (133) may be distanced from the light source (110).

The reflective surface (135) is a plane reflective of light incident through the incident surface (131). At this time, the reflective surface (135) may totally reflect the light. The reflective surface (135) may reflect the light to a lateral direction, an upper lateral direction and a bottom lateral direction. That is, the reflective surface (135) can reflect the light to the light emitting surface (137). As a result, the reflective surface (135) can prevent a hot spot from being generated by an excessive concentration of light to a center portion of the luminous flux control member (130).

The reflective surface (135) is arranged opposite to the incident surface (133). At this time, a center of the reflective surface (135) is arranged on the OA of the light source (110). Furthermore, the reflective surface (135) is arranged on the depression unit (131). At this time, the reflective surface (135) is an inner surface of the depression unit (131). That is, the reflective surface (135) is extended to the OA of the light source (110). At this time, the reflective surface (135) may be orthogonal to the OA of the light source (110), or may be extended to a slanting outside direction. At this time, a distance between the reflective surface (135) and the OA of the light source (110) may be gradually distanced from the light source (110) as being distanced from the light source (110). Furthermore, the reflective surface (135) may encompass the OA of the light source (110). In addition, the reflective surface (135) may be spherical or aspheric.

The light emitting surface (137) is a plane from which the light incident from the incident surface (133) or the light reflected from the reflective surface (135) is emitted. At this time, the light emitting surface (137) may emit the light to a bottom lateral direction. That is, the light emitting surface (137) may emit the light to a bottom surface of a plane perpendicular to the OA of the light source (110), where the light emitting surface (137) may refract the light.

The light emitting surface (137) is extended from the reflective surface (135). At this time, the light emitting surface (137) may be extended by being curved or bent. Furthermore, the light emitting surface (137) may be extended from the reflective surface (135) to the lateral bottom direction. That is, the light emitting surface (137) may be extended to approach the driving substrate (120). At this time, a distance between the light emitting surface (137) and the OA of the light source (110) may be gradually distanced from the reflective source (135) as being distanced from the reflective surface (135). Furthermore, the light emitting surface (137) encompasses the OA of the light source (110). In addition, the light emitting surface (137) may be spherical or aspheric.

The rear surface (139) serves to connect the incident surface (133) to the light emitting surface (137). The rear surface (139) is arranged opposite to the driving substrate (120). At this time, the rear surface (139) is distanced from the driving substrate (120). The rear surface (139) may be extended from the incident surface (133) to the light emitting surface (137). At this time, the rear surface (139) is extended to an outside direction orthogonal to the OA of the light source (110). At this time, the rear surface (139) may be arranged on a same plane as that of the incident surface (133). The rear surface (139) encompasses the OA of the light source (110). The rear surface (139) may encompass the incident surface (133).

The support member (140) supports the luminous flux control member (130) on the driving substrate (120). That is, the support member (140) distances the luminous flux control member (130) from the driving substrate (120). Furthermore, the support member (140) arranges the luminous flux control member (130) on the light source (110). At this time, the support member (140) may be interposed between the driving substrate (120) and the luminous flux control member (130).

The support member (140) is mounted on the driving substrate (120). At this time, the support member (140) may be tightly abutted to the driving substrate (120). That is, the support member (140) may be directly brought into contact with the driving substrate (120). At this time, the support member (140) is formed with an accommodation hole (141). The accommodation hole (141) corresponds to the light source (110). At this time, the accommodation hole (141) may be formed at a center of the support member (140). Furthermore, a center of the accommodation hole (141) may be arranged on the OA of the light source (110). Furthermore, the light source (110) is arranged inside the accommodation hole (141). That is, the accommodation hole (141) accommodates the light source (110). At this time, the support member (140) encompasses the light source (110).

Furthermore, the support member (140) is coupled to the luminous flux control member (130). At this time, the luminous flux control member (130) may be mounted on the support member (140). At this time, the luminous flux control member (130) may be mounted on the support member (140) through an edge portion. Furthermore, the support member (140) may be tightly brought into contact with the luminous flux control member (130). At this time, the support member (140) may be directly brought into contact with a rear surface (139) of the luminous flux control member (130). Furthermore, the luminous flux control member (130) and the light source (110) may face each other in the accommodation hole (141) of the support member (140). At this time, an incident surface (133) of the luminous flux control member (130) faces the light source (110).

At this time, the support member (140) is formed with a predetermined height (H). The height (H) of the support member (140) may be same as a thickness (T) of the light source (110), whereby the luminous flux control member (130) may be brought into tight contact with the light source (110). That is, the incident surface (133) of the luminous flux control member (130) may be directly brought into contact with the light source (110). Alternatively, the height (H) of the support member (140) may be greater than the thickness (T) of the light source (110), whereby the luminous flux control member (130) can be distanced from the light source (110). That is, the incident surface (133) of the luminous flux control member (130) may be distanced from the light source (110).

The support member (140) is formed with a transparent material. At this time, the support member (140) may be formed with a same material as that of the luminous flux control member (130). Alternatively, the support member (140) may be formed with a different material from that of the luminous flux control member (130). At this time, a support member (140) may be approximately 1.4 to 1.5. The support member (140) may be formed with a transparent resin. To be more specific, the support member (140) may include a thermoplastic resin. At this time, the support member (140) may include silicon resin. By way of non-limiting example, the support member (140) may be formed with PDMS (Polydimethylsiloxane) or PMMA (Polymethylmethacrylate).

The reflective unit (150) reflects the light reflected from the luminous flux control member (130). At this time, the reflective unit (150) reflects the light in a lambertian type. That is, the reflective unit (150) scatters the light. At this time, the reflective unit (150) may be formed with fine patterns. The fine patterns on the reflective unit (150) may scatter the light. Furthermore, the reflective unit (150) may totally reflect the light. Furthermore, the reflective unit (150) may reflect the light to an upper lateral direction.

The reflective unit (150) is mounted on the driving substrate (120). At this time, the reflective unit (150) is distanced from the luminous flux control member (130) to a first direction. The reflective unit (150) is extended to a second direction. At this time, the reflective unit (150) may be distanced from the luminous flux control member (130) to a second direction. Furthermore, the reflective unit (150) may be extended to the second direction and to the first direction as well. That is, the reflective unit (150) may encompass the OA of the light source (110).

Furthermore, the reflective unit (150) may be abutted to the driving substrate (120) in a flat manner. Alternatively, the reflective unit (150) may be protrusively formed on the driving substrate (120). At this time, a cross-section of the reflective unit (150) may take a shape of a circle, a triangle, a rectangle or a lozenge. Furthermore, the reflective unit (150) may be formed with an inorganic material. By way of non-limiting example, the reflective unit (150) may be formed with a silicon oxide, a silicon oxide nitride, a silicon nitride, a silicon oxide carbide, an aluminum oxide, a niobium oxide or a titanium oxide. Alternatively, the reflective unit (150) may be formed with an organic material. By way of non-limiting example, the reflective unit (150) may be formed with parylene.

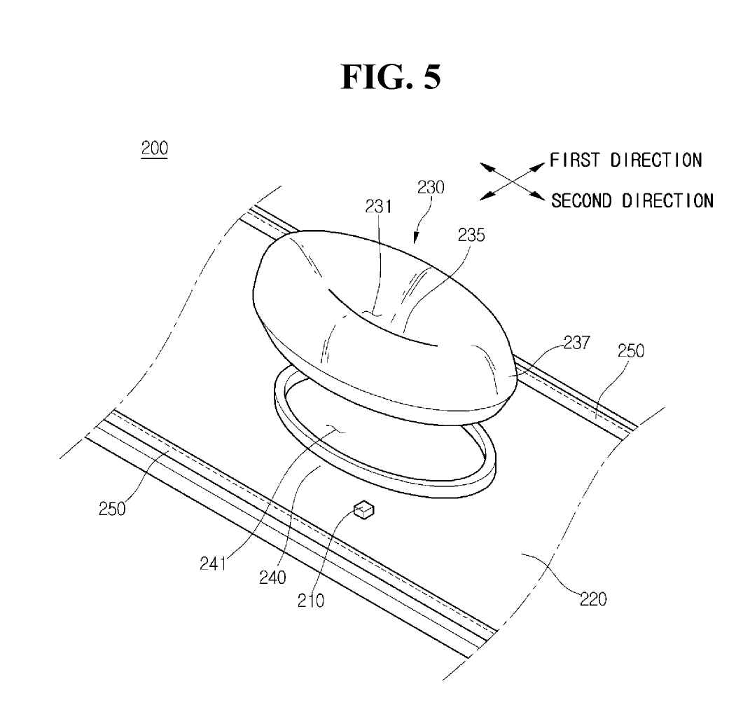

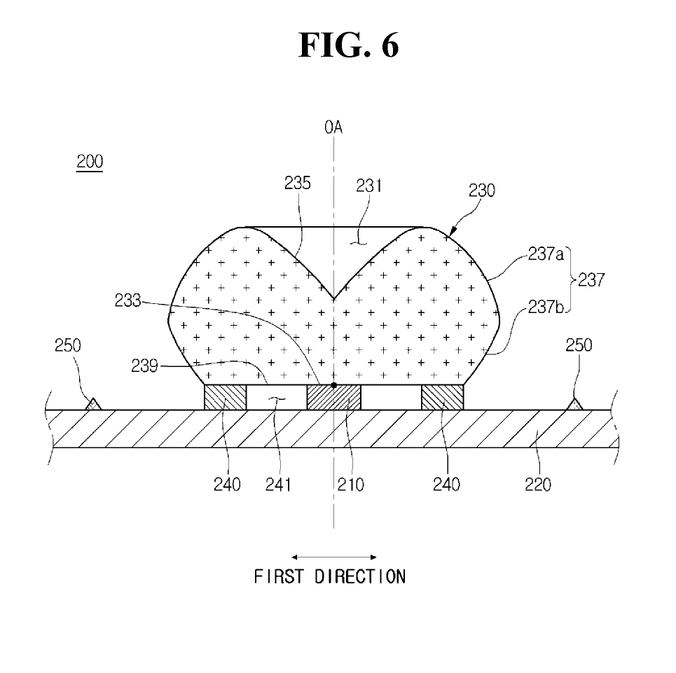

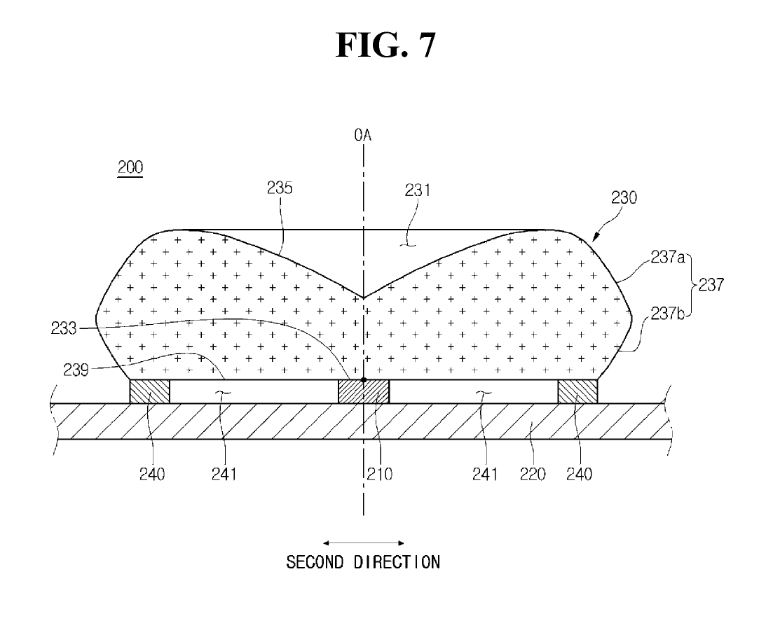

FIG. 5 is an exploded perspective view illustrating a light emitting device according to a second exemplary embodiment of the present invention, FIG. 6 is a cross-sectional view illustrating a cross-section based on a first direction of a light emitting device according to a second exemplary embodiment of the present invention, and FIG. 7 is a cross-sectional view illustrating a cross-section based on a second direction of a light emitting device according to a second exemplary embodiment of the present invention.

Referring to FIGS. 5, 6 and 7, a light emitting device (200) according to a second exemplary embodiment of the present invention includes a driving substrate (220), a luminous flux control member (230), a support member (240) and a reflective unit (250).

At this time, the luminous flux control member (230) may be formed with a depression (dent) unit (231). The luminous flux control member (230) includes an incident surface (233), a reflective surface (235), a light emitting surface (237) and a rear surface (239). Furthermore, the support member (240) is formed with an accommodation hole (241). Each of the configurations in the light emitting device (200) according to the second exemplary embodiment of the present invention corresponds to that of the previous exemplary embodiment, such that detailed explanation thereto will be omitted.

However, in the luminous flux control member (230) according to the second exemplary embodiment of the present invention, the light emitting surface (237) includes a first light emitting surface (237a) and a second light emitting surface (237b). At this time, at least one of the first light emitting surface (237a) and the second light emitting surface (237b) emits light to a lateral bottom surface. That is, at least one of the first light emitting surface (237a) and the second light emitting surface (237b) emits light to a bottom surface of a plane vertical to an OA of a light source (210). At this time, at least one of the first light emitting surface (237a) and the second light emitting surface (237b) may refract the light.

The first light emitting surface (237a) is extended from the reflective surface (235). At this time, the first light emitting surface (237a) is extended by being bent or curved from the reflective surface (235). Furthermore, the first light emitting surface (237a) is extended to a lateral bottom direction from the reflective surface (235). That is, the first light emitting surface (237a) is extended from the OA of the light source (210) to a direction being inclined at a first gradient. At this time, a distance between the first light emitting surface (237a) and the OA of the light source (210) may gradually recede as being distanced from the reflective surface (235). Furthermore, the first light emitting surface (237a) may be spherical or aspheric.

The second light emitting surface (237b) is extended from the rear surface (239). At this time, the second light emitting surface (237b) is extended by being bent or curved from the rear surface (239). Furthermore, the second light emitting surface (237b) is extended to a first light emitting surface from the rear surface (239). That is, the second light emitting surface (237b) is bent or curved from the first light emitting surface (237a). Furthermore, the second light emitting surface (237b) is extended from the rear surface (239) to an upper lateral direction. That is, the second light emitting surface (237b) is extended from the OA of the light source (210) to a direction inclining at a second gradient. At this time, a distance between the second light emitting surface (237b) and the OA of the light source (210) may gradually get close as being distanced from the incident surface (233). Furthermore, the second light emitting surface (237b) may be spherical or aspheric.

Meanwhile, although the present exemplary embodiment has disclosed the light emitting surface (237) includes the first light emitting surface (237a) and the second light emitting surface (237b), the present invention is not limited thereto. That is, it should be apparent that the light emitting surface (237) according to the present exemplary embodiment may further include at least one light emitting surface (not shown) that is arranged between the first light emitting surface (237a) and the second light emitting surface (237b). At this time, in a case the light emitting surface (237) includes a plurality of other light emitting surfaces (not shown), the other light emitting surfaces may be connected in sequence to connect the first light emitting surface (237a) and the second light emitting surface (237b).

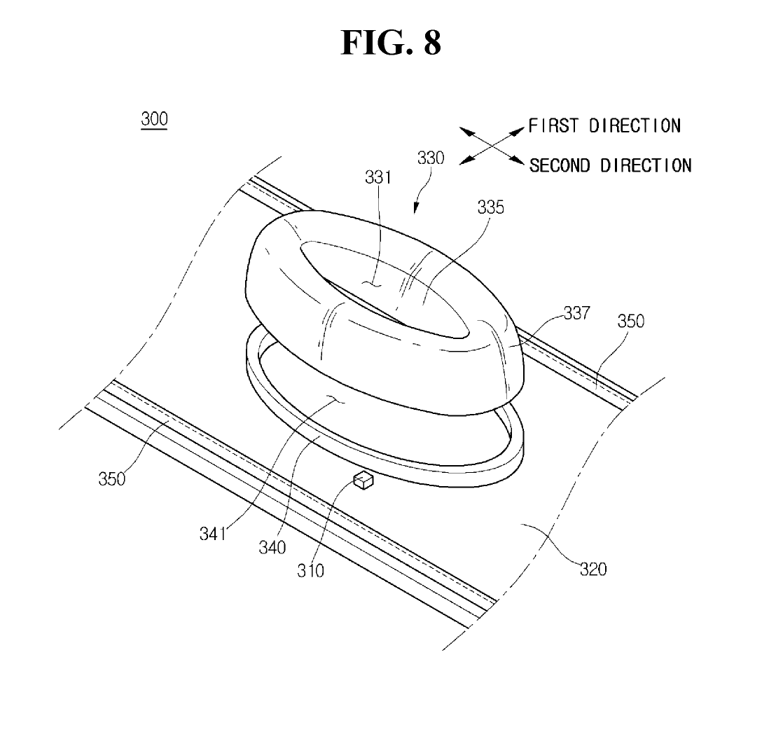

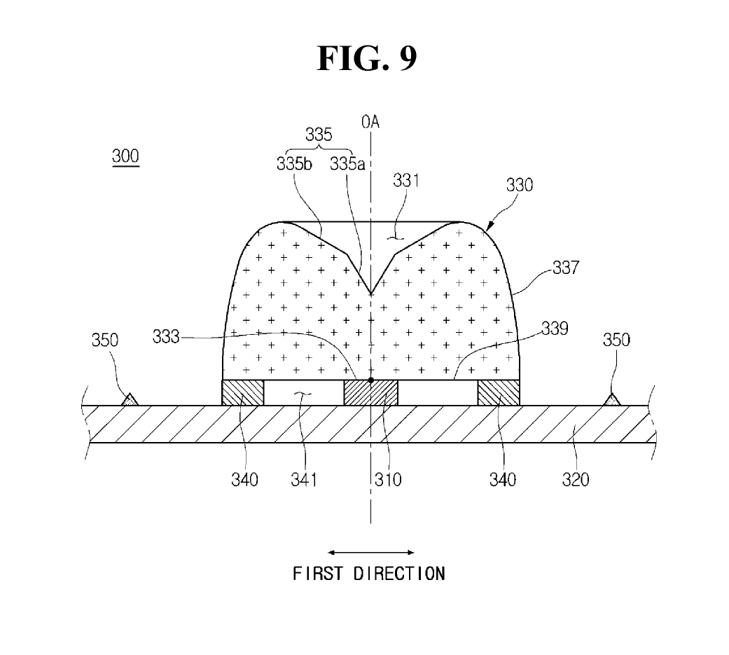

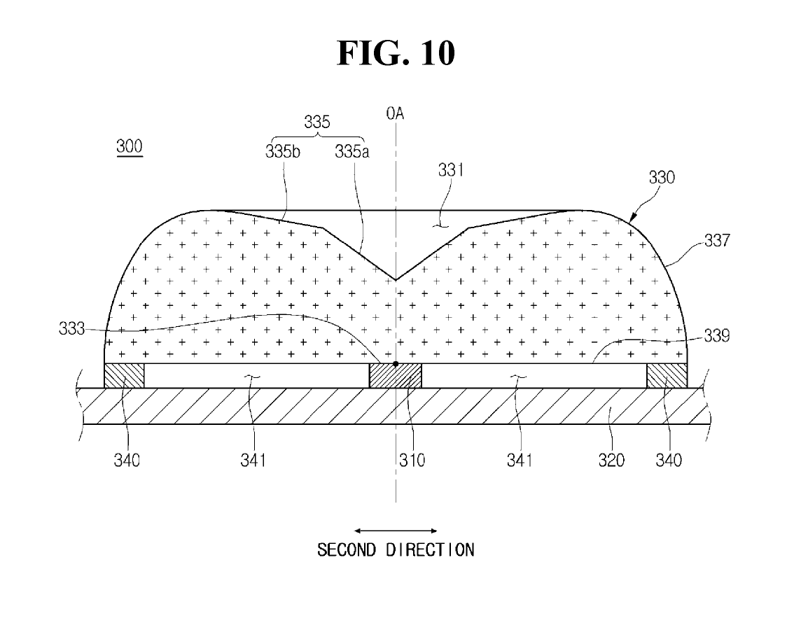

FIG. 8 is an exploded perspective view illustrating a light emitting device according to a third exemplary embodiment of the present invention, FIG. 8 is a cross-sectional view illustrating a cross-section of a light emitting device according to an exemplary embodiment of the present invention, FIG. 9 is a cross-sectional view illustrating a cross-section based on a first direction of a light emitting device according to a third exemplary embodiment of the present invention, and FIG. 10 is a cross-sectional view illustrating a cross-section based on a second direction of a light emitting device according to a third exemplary embodiment of the present invention.

Referring to FIGS. 8, 9 and 10, a light emitting device (300) according to the third exemplary embodiment of the present invention includes a light source (310), a driving substrate (320), a luminous flux control member (330), a support member (340) and a reflective unit (350). At this time, the luminous flux control member (330) is formed with a depression (dent) unit (331).

The luminous flux control member (330) includes an incident surface (333), a reflective surface (335), a light emitting surface (337) and a rear surface (339). Each of the configurations in the light emitting device (300) according to the third exemplary embodiment of the present invention corresponds to that of the previous exemplary embodiment, such that detailed explanation thereto will be omitted.

However, in the luminous flux control member (330) according to the third exemplary embodiment of the present invention, the reflective surface (335) includes a first reflective surface (335a) and a reflective surface (335b). At this time, the first reflective surface (335a) and the second reflective surface (335b) emits light to the light emitting surface (337).

The first reflective surface (335a) is extended from an OA of the light source (310). At this time, the first reflective surface (335a) is orthogonal to an OA of the light source (310) or extended to a direction inclined to an outside direction. That is, the first reflective surface (335a) is extended from the OA of the light source (310) to a direction inclined at a third gradient. A distance between the first reflective surface (335a) and the OA of the light source (310) may gradually recede as being distanced from the light source (310). Furthermore, the reflective surface (335a) may encompass the OA of the light source (310). The first reflective surface (335a) may be spherical or aspheric.

The second reflective surface (335b) is extended from the light emitting surface (337). At this time, the second reflective surface (335b) is bent or curved from the light emitting surface (337). Furthermore, the second reflective surface (335b) is extended to the first reflective surface (335a) from the light emitting surface (337). At this time, the second reflective surface (335b) is bent or curved from the first reflective surface (335a). Furthermore, the second reflective surface (335b) is extended from the light emitting surface (337) to a lateral bottom surface. That is, the second reflective surface (335b) is extended from the OA of the light source (310) to a direction being inclined at a fourth gradient. At this time, a distance between the second reflective (335b) and the OA of the light source (310) may gradually recede as being distanced from the light source (310). Furthermore, the second reflective surface (335b) may encompass the OA of the light source (310). Furthermore, the second reflective surface (335B) may be spherical or aspheric, whereby the light emitting surface (337) emits light reflected from the first and second reflective surfaces (335a, 335b).

Meanwhile, although the present exemplary embodiment has disclosed the reflective surface (335) includes the first reflective surface (335a) and the second reflective surface (335b), the present invention is not limited thereto. That is, it should be apparent that the reflective surface (335) according to the present exemplary embodiment may further include at least one reflective surface (not shown) that is arranged between the first reflective surface (335a) and the second reflective surface (335b). At this time, in a case the reflective surface (335) includes a plurality of other reflective surfaces (not shown), the other reflective surfaces may be connected in sequence to connect the first and second reflective surfaces (335, 335b).

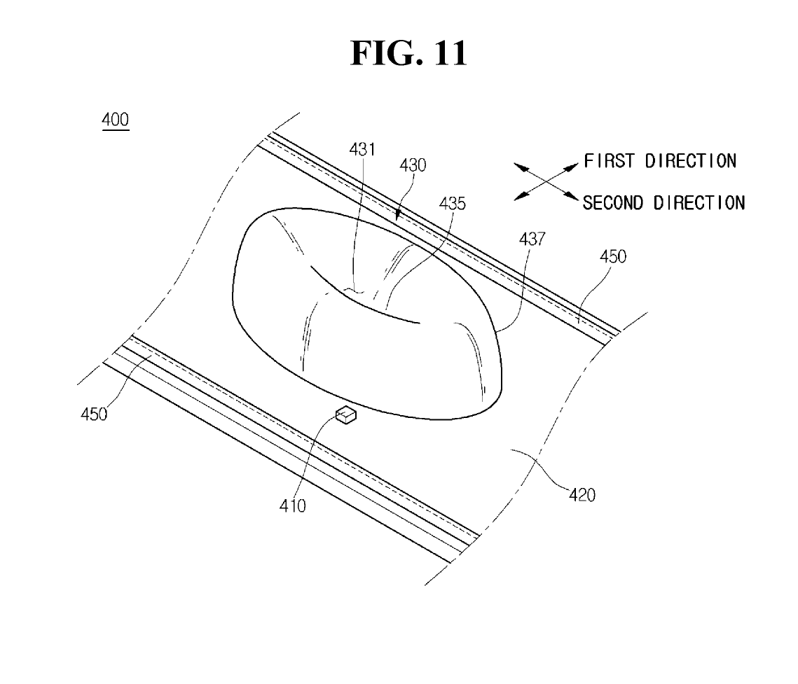

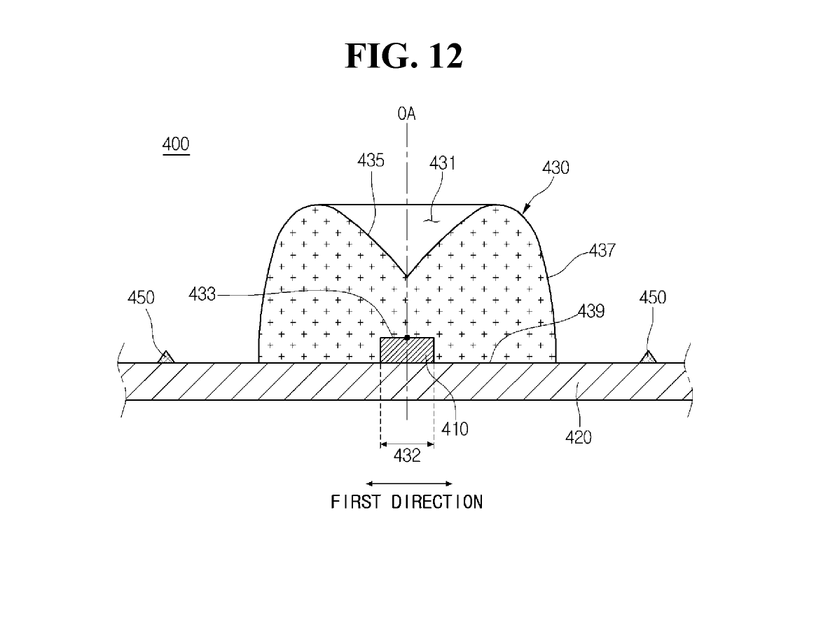

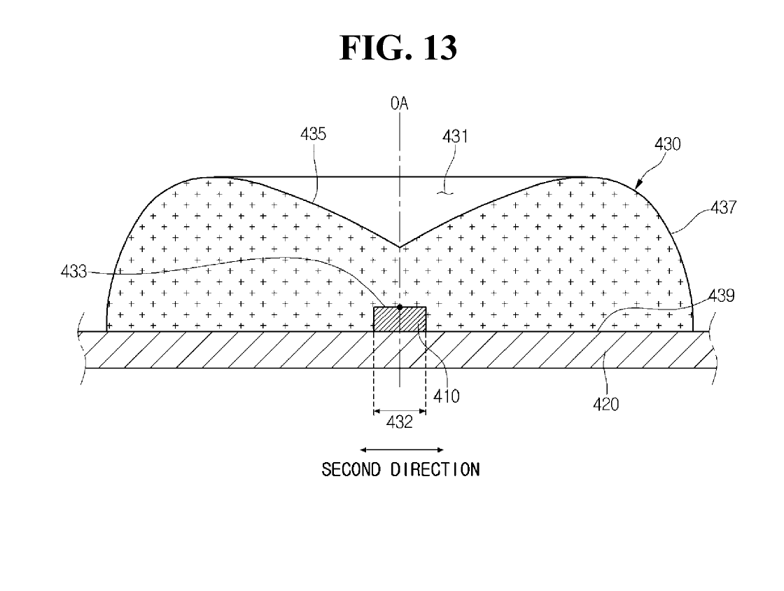

FIG. 11 is an exploded perspective view illustrating a light emitting device according to a fourth exemplary embodiment of the present invention, FIG. 12 is a cross-sectional view illustrating a cross-section based on a first direction of a light emitting device according to a fourth exemplary embodiment of the present invention, and FIG. 13 is a cross-sectional view illustrating a cross-section based on a second direction of a light emitting device according to a fourth exemplary embodiment of the present invention;

Referring to FIGS. 11, 12 and 13, a light emitting device (400) according to the fourth exemplary embodiment of the present invention includes a light source (410), a driving substrate (420), a luminous flux control member (430), and a reflective unit (350). At this time, the luminous flux control member (430) is formed with a depression (dent) unit (431).

The luminous flux control member (430) includes an incident surface (433), a reflective surface (435), a light emitting surface (437) and a rear surface (439). Each of the configurations in the light emitting device (400) according to the fourth exemplary embodiment of the present invention corresponds to that of the previous exemplary embodiment, such that detailed explanation thereto will be omitted.

However, in the light emitting device (400) according to the fourth exemplary embodiment of the present invention, the luminous flux control member (430) is directly mounted on the driving substrate (420). To this end, the luminous flux control member (430) may be further formed with a concave unit (432).

The concave unit (432) is formed at a bottom surface of the luminous flux control member (430). The concave unit (432) faces the depression unit (431). The concave unit (432) is concavely formed toward the depression unit (431). That is, the concave unit (432) is formed at a center of the luminous flux control member (430). At this time, a center of the concave unit (432) is arranged on an OA of the light source (410). That is, the concave unit (432) is formed with an axially symmetrical structure about the OA of the light source (410). The concave unit (432) may accommodate a part or a total area of the light source (410). That is, the light source (410) may be arranged inside the concave unit (432).

At the same time, the incident surface (433) is arranged on the concave unit (432) in the luminous flux control member (430). At this time, the incident surface (433) is an inner surface of the concave unit (432). At this time, the incident surface (433) may be tightly abutted to the light source (410). That is, the incident surface (433) may be directly brought into contact with the light source (410). Furthermore, the rear surface (439) may be tightly brought into contact with the driving substrate (420) in the luminous flux control member (430). That is, the rear surface (439) is directly brought into contact with the driving substrate (420).

Meanwhile, although the present exemplary embodiment has illustrated and explained that the luminous flux control member (430) is directly mounted on the driving substrate (420), as the luminous flux control member (430) includes the concave unit (432), the present invention is not limited thereto. That is, even if the luminous flux control member (430) includes the concave unit (432), it is possible to implement the present invention lest the luminous flux control member (430) should be directly mounted on the driving substrate (420). At this time, the luminous flux control member (430) may be mounted on the driving substrate (420) via a support member (not shown).

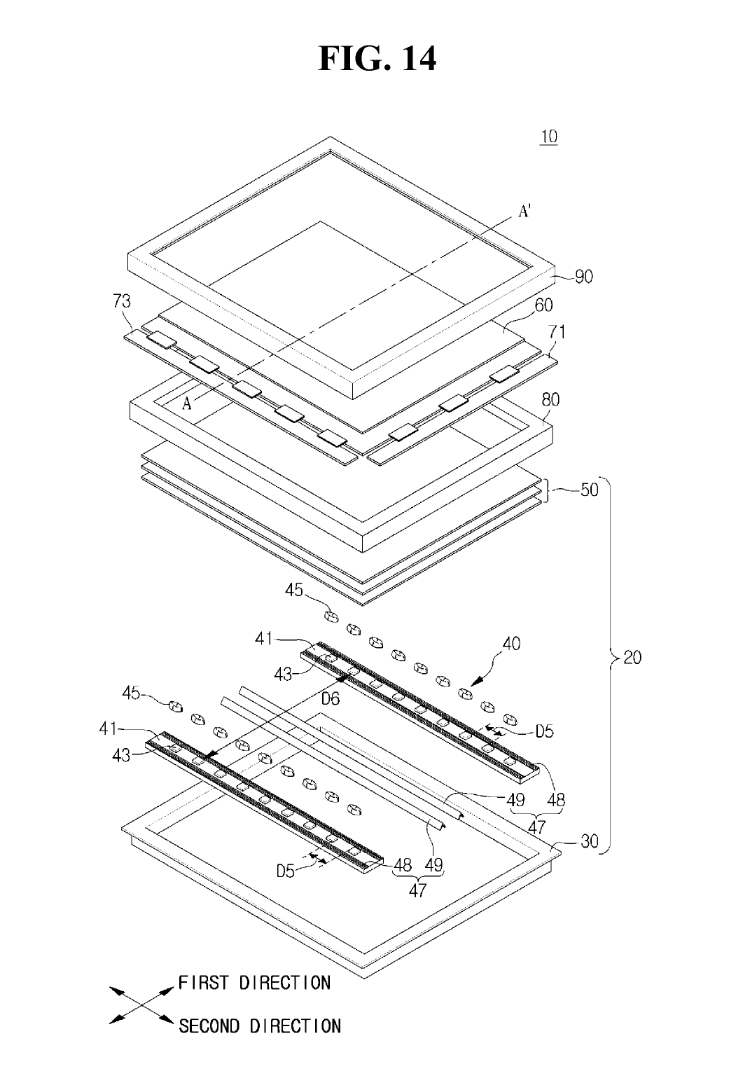

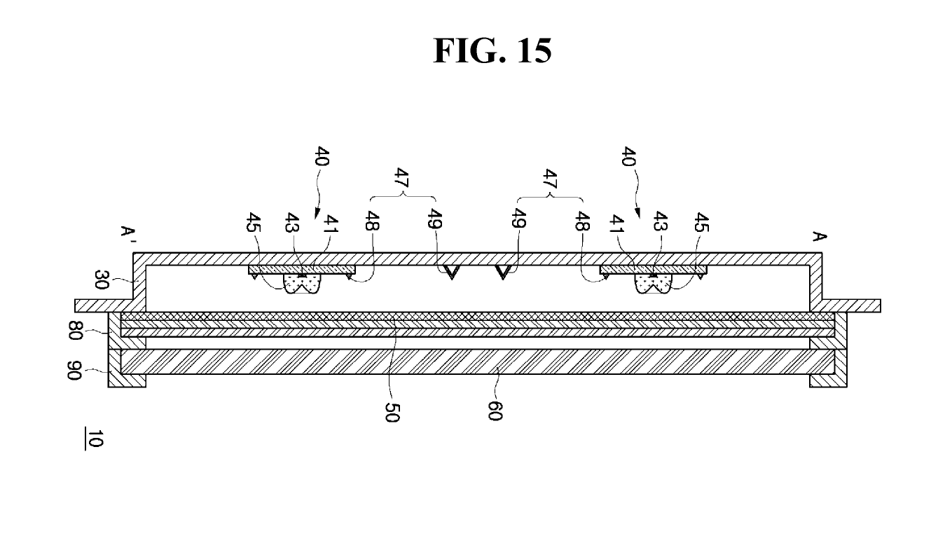

FIG. 14 is an exploded perspective view illustrating a display device according to an exemplary embodiment of the present invention, and FIG. 15 is a cross-sectional view illustrating a cross-section cut along line A-A′ of FIG. 14.

Referring to FIGS. 14 and 15, a display device (10) according to an exemplary embodiment of the present invention includes a backlight unit (20), a display panel (60), panel control substrates (71, 73), a panel guide (80) and an upper case (90).

The backlight unit (20) serves to generate and output light. At this time, the backlight unit (20) may be embodied in a direct method according to the exemplary embodiment of the present invention. The backlight unit (20) includes a bottom cover (30), a light emitting device (40) and at least one optical sheet (50).

The bottom cover (30) is embodied in an upper surface-opened box shape. The bottom cover (30) accept the light emitting device (40) through an upper surface, and serves to support and protect the light emitting device (40). The bottom cover (30) supports the optical sheet (50) and the display panel (60). At this time, the bottom cover (30) may be formed with a metal. By way of non-limiting example, the bottom cover (30) may be formed by bending or curving a metal plate. At this time, because the metal plate is bent or curved, the bottom cover (30) may be formed with an insertion space of the light emitting device (40).

The light emitting device (40) includes a plurality of driving substrates (41), a plurality of light sources (43), a plurality of luminous flux control members (45) and a plurality of reflective units (47).

The driving substrates (41) function to support the light sources (43) and the luminous flux control members (45). Furthermore, the driving substrates (41) control the driving of the light sources (43). That is, the driving substrates (41) transmit driving signals to the light sources (43).

The driving substrates (41) are distanced to a first direction to be extended in parallel thereamong. The driving substrates (41) are extended to a second direction. At this time, each of the driving substrates (41) may take a shape of a bar lengthily formed to the second direction. Furthermore, the number of driving substrates (41) may be determined by an area of the display panel (60). At this time, the area of the display panel (60) may be determined by a width corresponding to the first direction and a length corresponding to the second direction. Furthermore, the width corresponding to the first direction of the driving substrates (41) may be determined by width of the display panel (60). At this time, each width of the driving substrates (41) may be approximately 5 mm˜3 mm. At the same time, the length corresponding to the second direction of the driving substrates (41) may be determined by a length of the display panel (60).

The light sources (43) are electrically connected to the driving substrates (41). The light sources (43) are driven under the control of the driving substrates (41) to generate light. The light sources (43) are mounted on the driving substrates (41). At this time, each of the light sources (43) is arranged in a row to the second direction on each of the driving substrate (41). Furthermore, each of the light sources (43) is distanced from each of the driving substrate (41) at a predetermined gap. At this time, a first gap (D5) of the light sources (43) on each of the driving substrates (41) is smaller than a second gap (D6) of the light sources (43) among the driving substrates (41). By way of example, the second gap (D6) may be greater than the first gap (D5) by approximately 1.3˜10 times.

The luminous flux control members (45) diffuse the light generated by the light sources (43). At this time, each of the luminous flux control members (45) may have an anisotropic structure. Furthermore, light is less diffused to a second direction than a first direction on the luminous flux control members (45). At this time, the luminous flux control members (45) emit light to a bottom surface of a plane perpendicular to an OA of the light source (43), where the luminous flux control members (45) may emit light to a bottom surface of the plane perpendicular to the OA, based on the first direction. The luminous flux control members (45) individually cover the light sources (43) on the driving substrates (41).

The reflective units (47) reflect light emitted from the luminous flux control members (45). At this time, the reflective units (47) reflect the light toward the display panels (47). At this time, the reflective units (47) reflect the light in the lambertian type. That is, the reflective units (47) scatter the light. Furthermore, the reflective units (47) include first reflective units (48) and second reflective units (49).

The first reflective units (48) are mounted on the driving substrates (41). At this time, the first reflective units (48) are distanced from the luminous flux control members (45) to a first direction on each of the driving substrates (41). Furthermore, the first reflective units (48) are extended to a second direction on each of the driving substrates (41). At this time, the first reflective units (48) may be distanced from the luminous flux control members (45) to the second direction on each of the driving substrates (41). Furthermore, the first reflective units (48) may be extended to the second direction as well as to the first direction on each of the driving substrates (41). Furthermore, the first reflective units (48) may be abutted in a flat manner on each of the driving substrates (41). Furthermore, the first reflective units (48) may be protruded upwards from each of the driving substrates (41). At this time, a cross-section of the first reflective unit (48) may take a shape of a half circle, a triangle, a rectangle or a lozenge.

The second reflective units (49) are mounted on the bottom cover (30). At this time, the second reflective units (49) on the bottom cover (30) are distanced from the luminous flux control members (45) to the first direction. Furthermore, the second reflective units (49) on the bottom cover (30) are extended to the second direction. That is, the second reflective units (49) may be extended to the second direction among the driving substrates (41). Furthermore, the second reflective units (49) may be abutted to the bottom cover (30) in a flat manner. Alternatively, the second reflective units (49) may be protruded upward from the bottom cover (30). At this time, a cross-section of the second reflective unit (49) may take a shape of a half circle, a triangle, a rectangle or a lozenge.

The optical sheet (50) passes the light by enhancing the characteristics of light incident from the light emitting device (40). At this time, the optical sheet (50) may be a polarizing sheet, a prism sheet, or a diffusive sheet, for example.

The display panel (60) performs a function of displaying an image using light inputted from the backlight unit (20). The display panel (60) is mounted on the backlight unit (20) through a rear surface.

Although not illustrated, the display panel (60) includes, for coherence to maintain a uniform gap by facing each other, a TFT (Thin Film Transistor) substrate, a C/F (Color Filter) substrate and a liquid crystal layer interposed between the TFT substrate and the C/F substrate. The TFT substrate changes alignment of liquid in the liquid crystal layer, whereby the TFT substrate changes an optical transmittance of light having passed the optical sheet. The TFT substrate is structurally configured such that a plurality of gate lines is formed, a plurality of data lines crossing the plurality of data lines is formed and TFTs are formed at a crossing area between the gate lines and the data lines. Furthermore, the C/F substrate expresses the light having passed the liquid crystal layer in a predetermined color.

Panel control substrates (71, 73) are provided to control the display panel (60). The panel control substrates (71, 73) include a gate driving substrate (71) and a data driving substrate (73). At this time, the panel control substrates (71, 73) are electrically connected to the liquid crystal display panel (60) by a COF (Chip On Film), where the COF may be changed to a TCP (Tape Carrier Package). The panel guide (80) supports the display panel (60). The panel guide (80) is arranged between the backlight unit (20) and the display panel (60). The upper case (90) is constructed to encompass an edge of the display panel (60), and may be coupled to the panel guide (80).

Meanwhile, although the present exemplary embodiment has explained and illustrated that the reflective units (47) are all mounted on the bottom cover (30) and the driving substrates (41), the present invention is not limited thereto. That is, the reflective units (47) may be mounted on any one of the bottom cover (30) and the driving substrates (41) to implement the present invention. In other words, the reflective units (47) may include any one of the bottom cover (30) and the driving substrates (41) to implement the present invention.

According to the present invention, the luminous flux control members (45) can emit light to a bottom surface of the plane perpendicular to the OA of the light source (43) to allow the reflective unit (47) to reflect the light reflected from the luminous flux control members (45). At this time, the reflective unit (47) can reflect the light in the lambertian type to expand the coverage (range) of optical wavelength from the display panel (60), whereby the coverage of the optical wavelength at the display panel (60) can be overlapped. As a result, the display device (60) can have a more uniform color distribution. At the same time, as an optical diffusion range is expanded at the display device (10) to improve brightness uniformity of the display device (10), through which performance of the display device (10) can be enhanced.

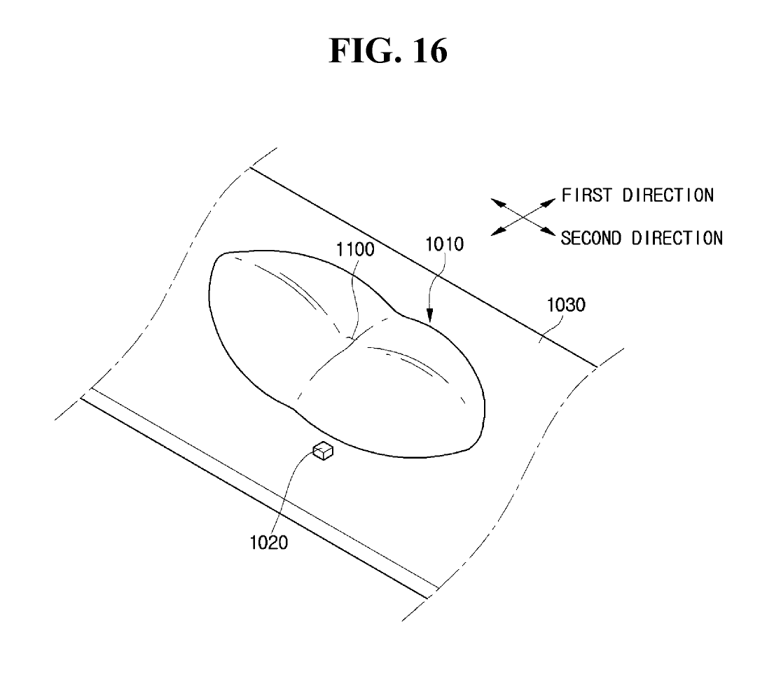

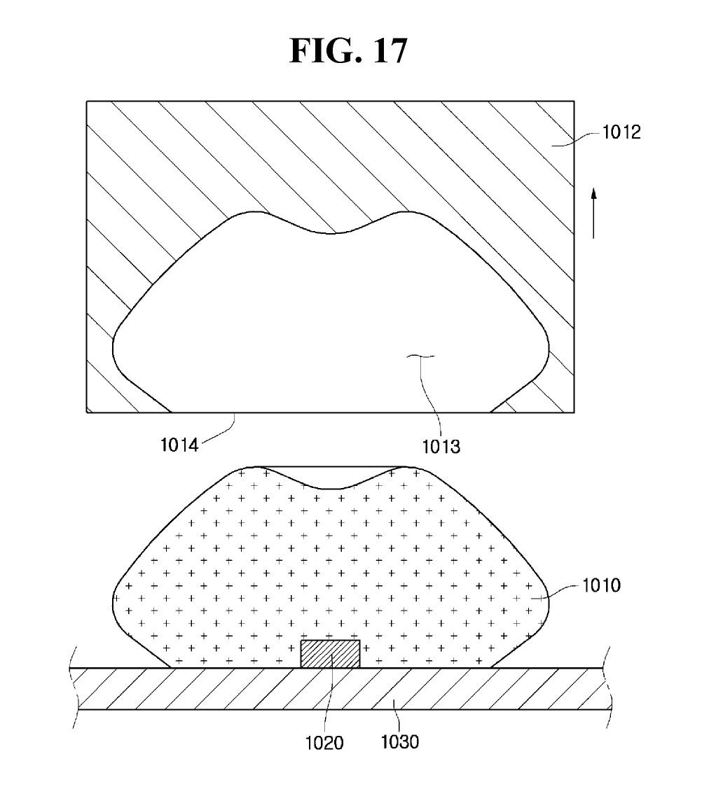

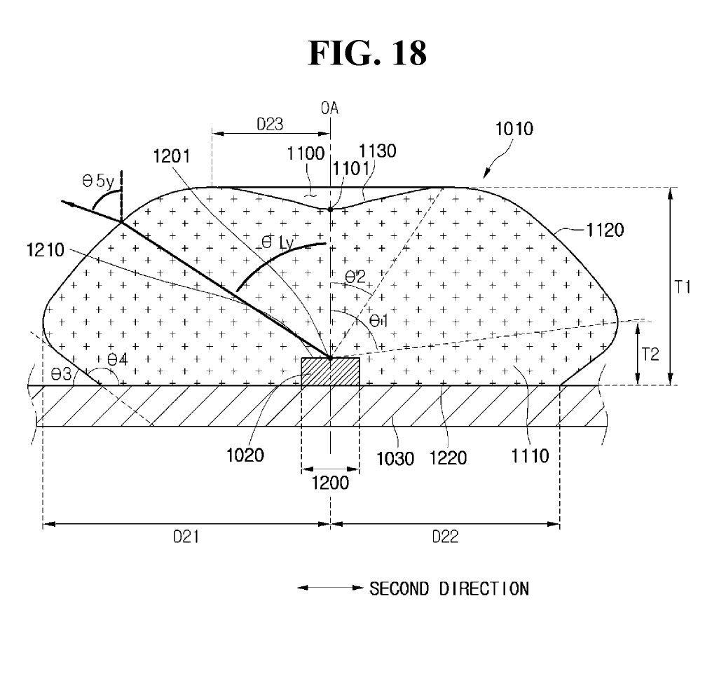

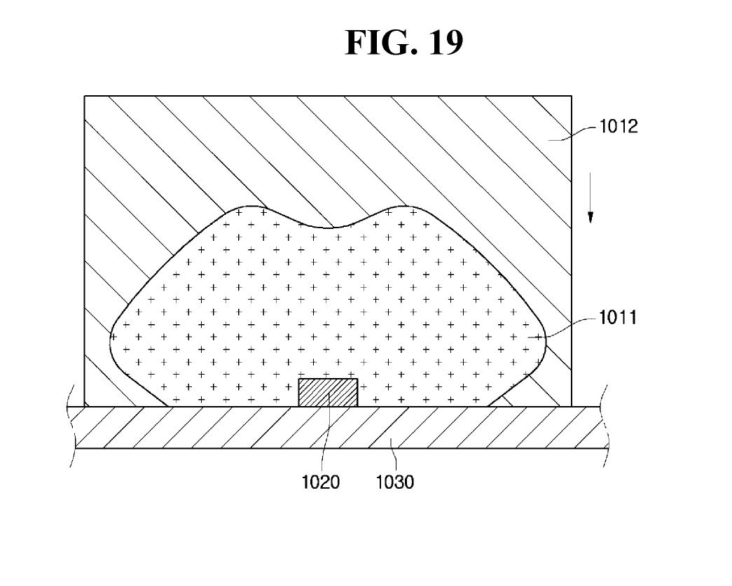

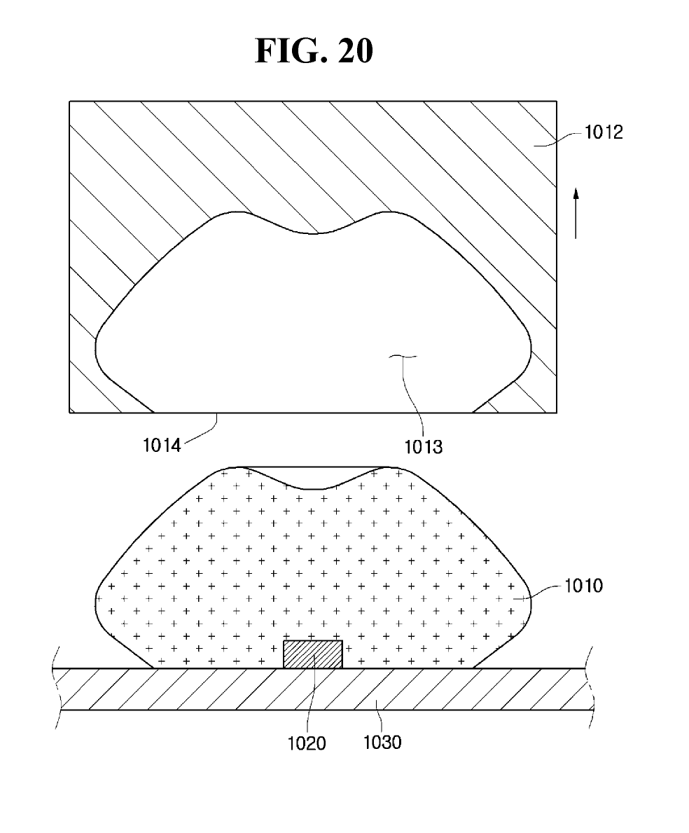

FIG. 16 is an exploded perspective view illustrating a display device according to a fifth exemplary embodiment of the present invention, FIG. 17 is a cross-sectional view illustrating a cross-section based on a first direction of a light emitting device according to a fifth exemplary embodiment of the present invention, FIG. 18 is a cross-sectional view illustrating a cross-section based on a second direction of a light emitting device according to a fifth exemplary embodiment of the present invention, and FIGS. 19 and 20 are schematic views illustrating a process of forming a luminous flux control member.

Referring to FIGS. 16 to 20, a light emitting device according to a fifth exemplary embodiment of the present invention includes a luminous flux control members (10), a light source, by way of non-limiting example, a light emitting diode (1020) and a driving substrate (1030).

The luminous flux control member (1010) is arranged on the driving substrate (1030). The luminous flux control member (1010) covers the light emitting diode (1020). The luminous flux control member (1010) may partially or totally accommodate the light emitting diode (1020). The luminous flux control member (1010) is incident with light emitted from the light emitting diode (1020). The luminous flux control member (1010) may be directly arranged on the light emitting diode (1020), and light from the light emitting diode (1020) may be directly incident on the luminous flux control member (1010).

The luminous flux control member (1010) includes an incident surface (1210), and refractive surfaces (1110, 1120, 1130) and a rear surface (1220).

The incident surface (1210) is a plane where light is incident from the light emitting diode (1020). The incident surface (1210) is a plane facing the light emitting diode (1020). The incident surface (1210) may directly be brought into contact with the light emitting diode (1020). To be more specific, the incident surface (1210) may be a plane directly and tightly contacting the light emitting diode (1020). Particularly, the luminous flux control member (1010) may be formed with a concave unit (1200).

The concave unit (1200) corresponds to the light emitting diode (1020). Furthermore, the concave unit (1200) faces a depressed (dent) unit (1100). The concave unit (1200) is formed underneath the luminous flux control member (1010). That is, the concave unit (1200) is formed at a bottom surface of the luminous flux control member (1010).

The concave unit (1200) is arranged with the light emitting diode (1020). To be more specific, a part or a total of the light emitting diode (1020) is arranged inside the concave unit (1200). That is, the part or the total of the light emitting diode (1020) is arranged inside the luminous flux control member (1010).

At this time, the light emitted from the light emitting diode (1020) may be incident through an inner surface of the concave unit (1200). As a result, the inner surface of the concave unit (1200) may be an incident surface (1210) to which the light is received. That is, the luminous flux control member (1010) may receive most of the light through the inner surface of the concave unit (1200). Alternatively, the luminous flux control member (1010) may not be formed with the concave unit (1200). At this time, the light emitting diode (1020) may be arranged at the flat rear surface (1220) of the luminous flux control member (1010). At this time, a part of the rear surface (1220) may be the incident surface (1210).

Furthermore, the luminous flux control member (1010) is formed with the depressed unit (1100). The depressed unit (1100) is formed at an upper surface of the luminous flux control member (1010). The depressed unit (1100) corresponds to the light emitting diode (1020). Furthermore, the depressed unit (1100) is depressed toward the light emitting diode (1020). Still furthermore, the depressed unit (1100) is caved in toward the light emitting diode (1020). The depressed unit (1100) is formed at a center of the luminous flux control member (1010).

A center (1101) of an inner surface of the depressed unit (1100) is arranged with an OA (Optical Axis) of the light emitting diode (1020). That is, the OA of the light emitting diode (1020) passes the center (101) of the inner surface of the depressed unit (1100).

Furthermore, a center (1201) of an inner surface of the concave unit (1200) may be arranged on the OA of the light emitting diode (1020). The OA of the light emitting diode (1020) may pass the center (1101) of inner surface (1110) of the depressed unit (2100) and the center (1201) of the inner surface of the concave unit (1200).

The refractive surfaces (1110, 1120, 1130) emit light from the incident surface (1210). Furthermore, the refractive surfaces (1110, 1120, 1130) refract the light incident to the luminous flux control member (1010). Each of the refractive surfaces (1110, 1120, 1130) may be formed with a curved surface on the whole. The refractive surfaces (1110, 1120, 1130) include a first refractive surface (1110), a second refractive surface (1120) and a recess surface (1130).

The first refractive surface (1110) is extended to the rear surface (1220). The refractive surface (1110) may be bent from the rear surface (1220) to be extended to a lateral upper direction. Furthermore, the first refractive surface (1110) may be extended from an upper surface of the driving substrate (1030) to a lateral upper direction.

That is, first refractive surface (1110) is extended from the rear surface (1220) to the second refractive surface (1120). The rear surface (1220) faces the driving substrate (1030). The rear surface (1220) is extended from an inner surface of the depression unit (1200) to a direction distancing from the OA of the light emitting diode (1020).

The first refractive surface (1110) may be a curved surface. To be more specific, the first refractive surface (1110) may be spherical or aspheric. The first refractive surface (1110) may emit light from the light emitting diode (1020). Furthermore, the first refractive surface (1110) may refract the light reflected from the recess surface (1130). The first refractive surface (1110) may be extended to a lateral upper direction from the recess surface (1220). That is, a distance from the OA of the light emitting diode (1020) to the first refractive surface (1110) may increase as distancing from the rear surface (1220). The distance from the OA of the light emitting diode (1020) to the first refractive surface (1110) may increase as distancing from the driving substrate (1030). That is, the first refractive surface (1110) may have an undercut structure based on an upper surface of the driving substrate (1030).

The second refractive surface (1120) is extended from an outside of the depression unit (1100) to a lateral bottom direction. Furthermore, the second refractive surface (1120) may be extended to an outside of the recess surface (1130) by being curved from the first refractive surface (1100). At this time, a distance between the second refractive surface (1120) and the OA of the light emitting diode (1020) may decrease as being distanced from the rear surface (1220). That is, the second refractive surface (1120) may approach the OA of the light emitting diode (1020) as being distanced from the first refractive surface (1110).

The second refractive surface (1120) may be spherical or aspheric. The second refractive surface (1120) may refract the light reflected by the recess surface (1130). To be more specific, the second refractive surface (1120) may refract the light reflected by the recess surface (1130) to a lateral direction, an upper lateral direction and a lateral bottom direction.

The second refractive surface (1120) may encompass a surrounding of the OA of the light emitting diode (1020). Furthermore, the second refractive surface (1120) may encompass a surrounding of the recess surface (1130).

The recess surface (1130) is an inner surface of the depression unit (1100). The recess surface (1130) may reflect the light from the light emitting diode (1020) to a lateral direction, an upper lateral direction and a lateral bottom direction.

The recess surface (1130) is extended from the OA of the light emitting diode (1020). To be more specific, the recess surface (1130) is extended to a direction distancing from the OA of the light emitting diode (1020). At this time, the direction distancing from the OA of the light emitting diode (1020) means a direction perpendicular to the OA of the light emitting diode (1020) or a direction inclining to the outside. To be more specific, the recess surface (1130) is extended to an upper lateral direction from the OA. The recess surface (1130) is extended to the outside from the OA of the light emitting diode (1020). At this time, the term of ‘OA’ is a progressing direction of light from a center of a 3-D luminous flux to a point light source.

Furthermore, the OA of the light emitting diode (1020) may pass the center (1101) of the refractive surfaces (1110, 1120, 1130) and the center (1210) of the incident surface (1210). That is, the OA of the light emitting diode (1020) may substantially coincide with a central axis of the luminous flux control member (1010). At this time, the central axis may be a straight line passing the center (1201) of the incident surface (1210) and the center (1101) of refractive surfaces (1110, 1120, 1130).

A distance between the recess surface (1130) and the OA of the light emitting diode (1020) may gradually increase as being distanced from the light emitting diode (1020). To be more specific, a distance between the recess surface (1130) and the OA of the light emitting diode (1020) may proportionally increase as being distanced from the light emitting diode (1020).

The recess surface (1130) may reflect the light emitted from the light emitting diode (1020). At this time, the recess surface (1130) may totally reflect the light emitted from the light emitting diode (1020). As a result, the recess surface (1130) can prevent a hot spot from being generated by an excessive concentration of light to a center portion of the luminous flux control member (1010). Furthermore, the recess surface (1130) may reflect the light emitted from the light emitting diode (1020) to the second refractive surface (1120) or to the first refractive surface (1110).

At this time, the term of ‘curvature’ means a slowly bending phenomenon. By way of non-limiting example, in a case two surfaces form a curved surface with a curvature radius greater than approximately 0.1 mm and are bent, it can be said that two surfaces are curved. At this time, the term of ‘inflection’ means that inclination of curvature is changed to be bent. By way of non-limiting example, the inflection may be the case where a convex curvature is bent to change to a concave curvature, or a concave curvature is bent to change to a convex curvature.

The rear surface (1220) is extended from the incident surface (1210). The rear surface (1220) is arranged opposite to an upper surface of the driving substrate (1030). The rear surface (1220) may be directly brought into contact with the upper surface of the driving substrate (1030). The rear surface (1220) may be arranged directly opposite to the upper surface of the driving substrate (1030).

The rear surface (1220) may be a flat plane. Furthermore, the rear surface (1220) may encompass a surrounding of the incident surface (1210). That is, the rear surface (1220) may be extended along a surrounding of the light emitting diode (1020).

The second refractive surface (1120) and the first refractive surface (1110) are formed at a lateral side of the luminous flux control member (1010).

The luminous flux control member (1010) is transparent. A refractive index of the luminous flux control member (1010) may be approximately 1.4 to 1.5. The luminous flux control member (1010) may be formed with a transparent resin. To be more specific, the luminous flux control member (1010) may include silicon resin. An example of material used for luminous flux control member (1010) may be PDMS (Polydimethylsiloxane).

The luminous flux control member (1010) may have a high elasticity. A young's modulus of the luminous flux control member (1010) may be approximately 100 kPa˜approximately 1,000 kPa.

Furthermore, an angle (θ₁) between the OA of the light emitting diode (1020) and a first straight line may be approximately 30° to approximately 85°, in a case the first straight line is defined by a line extended from the center (1201) of the incident surface (1210) to an area where the first and second refractive surfaces (1110, 1120) join. To be more specific, the angle (θ₁) between the OA of the light emitting diode (1020) and a first straight line may be approximately 45° to approximately 70°.

Furthermore, a line extended from the center (1201) of the incident surface (1210) to an area where the second refractive surface (1120) and the recess surface (1130) join may be defined as a second straight line. An angle (θ₂) between the OA of the light emitting diode (1020) and the second straight line may be approximately 5° to approximately 25°.

Furthermore, an angle (θ₃) between the first refractive surface (1110) and the upper surface of the driving substrate (1030) may be approximately 5° to approximately 70°. Furthermore, an angle (θ₄) between the first refractive surface (1110) and the rear surface (1220) may be approximately 110° to approximately 175°.

The luminous flux control member (1010) may have an anisotropic structure. The luminous flux control member (1010) may have a surface symmetrical structure instead of an axially symmetrical structure. The luminous flux control member (1010) may have a shape extended to a second direction. That is, the luminous flux control member (1010) may be formed relatively longer to the second direction, and relatively shorter to a first direction crossing the second direction. By way of non-limiting example, the luminous flux control member (1010) may have an oval structure when viewed from a top.

The first direction and the second direction may be vertical to each other. Furthermore, the second direction and the OA of the light emitting diode (1020) may be vertical to each other.

Referring to FIG. 17, a first distance (D12) is defined as being a distance from the OA of the light emitting diode (1020) to an area where the rear surface (1220) and the first refractive surface (1110) meet based on the first direction. Furthermore, a second distance (D22) is defined as being a distance from the OA of the light emitting diode (1020) to an area where the rear surface (1220) and the first refractive surface (1110) meet based on the second direction. At this time, the first distance (D12) may be shorter than the second distance (D22). A ratio between the first distance (D12) and the second distance (D22) may be approximately 1:1.5. In short, a distance from the light emitting diode (1020) to an outside of the rear surface (1220) based on the first direction may be shorter than a distance from the light emitting diode (1020) to an outside of the rear surface (1220) based on the second direction.

Referring to FIG. 17, a third distance (D11) is defined as being a distance from the OA of the light emitting diode (1020) to an area where the second refractive surface (1120) and the first refractive surface (1110) meet based on the first direction. Furthermore, as illustrated in FIG. 3, a fourth distance (D21) is defined as being a distance from the OA of the light emitting diode (1020) to an area where the second refractive surface (1120) and the first refractive surface (1110) meet based on the second direction. At this time, the third distance (D11) may be shorter than the fourth distance (D21). A ratio between the third distance (D11) and the fourth distance (D21) may be approximately 1:1.5 to 1:5.

Referring to FIG. 17, a fifth distance (D13) is defined as being a distance from the OA of the light emitting diode (1020) to an area where the second refractive surface (1120) and the recess surface (1130) meet based on the first direction. Furthermore, as illustrated in FIG. 18, a sixth distance (D23) is defined as being a distance from the OA of the light emitting diode (1020) to an area where the second refractive surface (1120) and the recess surface (1130) meet based on the second direction. At this time, the fifth distance (D13) may be shorter than the sixth distance (D23). A ratio between the fifth distance (D13) and the sixth distance (D23) may be approximately 1:1.5 to 1:5.

Furthermore, the third distance (D11) may be greater than the first distance (D12).

The third distance (D11) may be greater than the fifth distance (D13). The fourth distance (D21) may be greater than the second distance (D22). The fourth distance (D21) may be greater than the sixth distance (D23).

Furthermore, a first symmetrical surface passing the OA of the light emitting diode (1020) and extended to the first direction may be defined. That is, the OA of the light emitting diode (1020) may be arranged on the first symmetrical surface. At this time, the luminous flux control member (1010) may have a surface symmetrical structure relative to the first symmetrical surface. Furthermore, the incident surface, the rear surface (1220) and the refractive surface may have a surface symmetrical structure to the first symmetrical surface. That is, the luminous flux control member (1010) may be bisected to an equal size by the first symmetrical surface.

Furthermore, a second symmetrical surface passing the OA of the light emitting diode (1020) and extended to the second direction may be defined. That is, the OA of the light emitting diode (1020) may be arranged on the second symmetrical surface. At this time, the luminous flux control member (1010) may have a surface symmetrical structure relative to the second symmetrical surface. Furthermore, the incident surface, the rear surface (1220) and the refractive surface may have a surface symmetrical structure to the second symmetrical surface. That is, the luminous flux control member (1010) may be bisected to an equal size by the second symmetrical surface.

Furthermore, the luminous flux control member (1010) may be divided into four (4) equal parts of substantially equal size by the first and second symmetrical surfaces. As a result, the incident surface, the rear surface (1220) and the refractive surface may be divided into four (4) equal parts of substantially equal size by the first and second symmetrical surfaces.

Each of the refractive surfaces (1110, 1120, 1130) has a mutually different shape based on the first and second directions. That is, each of the refractive surfaces (1110, 1120, 1130) has a different shape based on the first direction from each of the refractive surfaces (1110, 1120, 1130) based on the second direction.

At this time, in a case the luminous flex control member (1010) is cut based on the first direction, the shape of each of the refractive surfaces (1110, 1120, 1130) based on the first direction means the shape of an area where the refractive surfaces (1110, 1120, 1130) and an area of cut surfaces meet. Likewise, in a case the luminous flex control member (1010) is cut based on the second direction, the shape of each of the refractive surfaces (1110, 1120, 1130) based on the second direction means the shape of an area where the refractive surfaces (1110, 1120, 1130) and an area of cut surfaces meet. To be more specific, the refractive surfaces (1110, 1120, 1130) have an anisotropic structure. That is, the refractive surfaces (1110, 1120, 1130) may have a surface symmetrical structure instead of axially symmetrical structure.

As a result, the refractive surfaces (1110, 1120, 1130) differently control the luminous flux depending on the first direction and the second direction. That is, beam angle (or beam spread angle) of light emitted from the refractive surfaces (1110, 1120, 1130) based on the first direction may be different from beam angle (or beam spread angle) of light emitted from the refractive surfaces (1110, 1120, 1130) based on the second direction. By way of non-limiting example, light incident from the light emitting diode (1020) and emitted through the refractive surfaces (1110, 1120, 1130) may have a first beam angle based on the first direction and have a second beam angle based on the second direction. At this time, the first beam angle may be greater than the second beam angle.

The refractive surfaces (1110, 1120, 1130) may control the light emitted from the light emitting diode (1020) to meet the following Equations 1 and 2.

θ5x/θ1x=ax>1 [Equation 1]

θ5y/θ1y=ay>1 [Equation 2]

At this time, θ1x is an angle formed between an arbitrary light incident through the incident surface and the OA of the light emitting diode (1020), that is, an emitting angle of light emitted from the light emitting diode (1020). In other words, θ1x is an angle formed between a light emitted at an arbitrary angle from the light emitting diode (1020) and the OA of the light emitting diode (1020) based on the first direction.

Furthermore, θ5x is an angle formed between light emitted through the refractive surfaces (1110, 1120, 1130) and the central axis, in a case light incident on the light emitting diode (1020) at the angle of θ1x is emitted through the refractive surfaces (1110, 1120, 1130) based on the first direction. That is, θ5x is an angle formed between light refracted through the refractive surfaces (1110, 1120, 1130) and the OA of the light emitting diode (1020) based on the first direction.

Furthermore, θ1y is an angle formed between an arbitrary light incident through the incident surface and the OA of the light emitting diode (1020) based on the second direction. That is, the θ1y is an angle of light emitted from the light emitting diode (1020) based on the second direction. In other words, the θ1y is an angle formed between an arbitrary light emitted from the light emitting diode (1020) and the OA of the light emitting diode (1020) based on the second direction.

θ5x is an angle of light emitted through the refractive surfaces (1110, 1120, 1130) and the central axis, in a case light incident on the luminous flux control member (1010) at an angle of θ1y is emitted through the refractive surfaces (1110, 1120, 1130). That is, θ5y is an angle formed between light refracted through the refractive surfaces (1110, 1120, 1130) and the OA of the light emitting diode (1020) based on the second direction.

Furthermore, ‘ax’ is different from ‘ay’. Particularly, ax may be greater than ay. To be more specific, the ax may be greater than ay by 1.1˜1.5 times. Furthermore, as θ1x increases, as ax may monotonously decrease. Furthermore, as θ1x increases, ay may monotonously decrease.

Still furthermore, the Equations 1 and 2 may be satisfied for light of θ1x being of 5 °˜90°. To be more specific, the Equations 1 and 2 may be satisfied for light of θ1x being of 10°˜80°. To be further specific, the Equations 1 and 2 may be satisfied for light of θ1x being of 15 °˜70°.

Still furthermore, the Equations 1 and 2 may be satisfied for light of θy1 being of 5 °˜90°. To be more specific, the Equations 1 and 2 may be satisfied for light of θy1 being of 10°˜80°. To be further specific, the Equations 1 and 2 may be satisfied for light of θy1 being of 15°˜70°. To be still further specific, the Equations 1 and 2 may be satisfied at the second refractive surface (1120).

Referring to FIGS. 17 and 18, the first refractive surface (1110) is extended from the rear surface (1220) to a lateral upper direction (side) based on the first and second directions. That is, a distance from the OA of the light emitting diode (1020) to the first refractive surface (1110) based on the first and second directions may gradually increase as being distanced from the rear surface (1220). A distance from the OA of the light emitting diode (1020) to the first refractive surface (1110) based on the first and second directions may gradually increase as being distanced from the driving substrate (1030). That is, based on the first and second directions, the first refractive surface (1110) may have an undercut structure based on an upper surface of the driving substrate (1030).

The luminous flux control member (1010) may be directly formed on the driving substrate (1030). Furthermore, the luminous flux control member (1010) may be directly formed on the light emitting diode (1020). The luminous flux control member (1010) may be directly brought into contact with on the driving substrate (1030) and the light emitting diode (1020). To be more specific, the luminous flux control member (1010) may be tightly abutted to the on the driving substrate (1030) and the light emitting diode (1020).

The luminous flux control member (1010) may be formed in the following manner.

Referring to FIG. 19, a resin composition (1011) is arranged on the driving substrate (1030) mounted with the light emitting diode (1020). The resin composition (1011) may include a thermosetting resin, a thermoplastic resin, or a photo-polymeric resin.

Thereafter, a mold (1012) accommodated on the driving substrate (1030). The mold (1012) is so arranged as to cover the light emitting diode (1020), whereby the resin composition (1011) is arranged inside a forming groove (1013) of the mold (1012). The forming groove (1013) of the mold (1012) may take a substantially same shape as that of the luminous flux control member (1010). That is, a minor diameter of the forming groove (1013) may gradually increase in size from an inlet (1014) to a floor, and then decrease. That is, the inlet of the forming groove (1013) may have a smaller diameter than an interior of the forming groove (1013).

Referring to FIG. 20, the resin composition (1011) inside the forming groove (1013) may be cooled or cured by heat/or light. As a result, the luminous flux control member (1010) is formed inside the forming groove (1013).

Thus, the luminous flux control member (1010) may be directly formed on an upper surface of the driving substrate (1030) and the light emitting diode (1020). That is, the luminous flux control member (1010) may be tightly abutted and directly formed on an upper surface of the driving substrate (1030) and the light emitting diode (1020). Thereafter, the mold (1012) is removed from the luminous flux control member (1010). At this time, because the luminous flux control member (1010) has a sufficient elasticity, and even if the inlet (1014) of the forming groove (1013) is smaller than the interior of the forming groove (1013), the mold (1012) can be easily removed. Alternatively, in a case the mold (1012) has a high elasticity, the mold (1012) can be easily separated.

By way of non-limiting example, a Young's modulus of the luminous flux control member (1010) and the mold (1012) may be approximately 100 kPa˜approximately 1,000 kPa.

As noted, the elasticity of the luminous flux control member (1010) and the mold (1012) may be adequately adjusted to allow the luminous flux control member (1010) to be easily formed on the driving substrate (1030). Particularly the first refractive surface (1110) has an undercut structure to allow the luminous flux control member (1010) to be easily formed on the driving substrate (1030).

Alternatively, the luminous flux control member (1010) may be attached to the driving substrate (1030) by an adhesive.

The light emitting diode (1020) generates light. The light emitting diode (1020) may be a point light source. The light emitting diode (1020) is electrically connected to the driving substrate (1030). The light emitting diode (1020) may be mounted on the driving substrate (1030). As a result, the light emitting diode (1020) receives an electrical signal from the driving substrate (1030). That is, the light emitting diode (1020) is driven by the driving substrate (1030) to thereby generate light.

The driving substrate (1030) supports the light emitting diode (1020) and the luminous flux control member (1010). Furthermore, the driving substrate (1030) is electrically connected to the light emitting diode (1020). The driving substrate (1030) may be a PCB (Printed Circuit Board). Furthermore, the driving substrate (1030) may be rigid or flexible.

Furthermore, the driving substrate (1030) may be extended to the second direction.

The driving substrate (1030) may take a shape of a strip that is extended to the second direction.

Although the present exemplary embodiment of the present invention has illustrated and explained a single driving substrate (1030) arranged by a single light emitting diode (1020) and a single luminous flux control member (1010), the present invention is not limited thereto. By way of non-limiting example, one driving substrate (1030) may be arranged by a plurality of light emitting diodes (1020). Furthermore, each of the light emitting diodes (1020) may be correspondingly arranged by each of the luminous flux control members (1010).

The light refracted by the recess surface (1130) may be selectively refracted by the first refractive surface (1110) or the second refractive surface (1120). Particularly, the luminous flux control member (1010) may be refracted as desired by a reflective angle of the recess surface (1130).

Particularly, the first refractive surface (1110) has an undercut structure that recedes from the OA of the light emitting diode (1020) as being distanced from the rear surface (1220). As a result, the first refractive surface (1110) can effectively refract the light directly incident through the incident surface (1210) to a lateral direction (side) or to an upper lateral direction (side). Furthermore, the first refractive surface (1110) can also effectively reflect the light reflected by the recess surface (1130) and the second refractive surface (1120) to a lateral direction (side) or to an upper lateral direction (side).

As a result, the luminous flux control member (1010) can effectively diffuse the light emitted from the light emitting diode (1020). Furthermore, the luminous flux control member (1010) can anisotropically diffuse the light emitted from the light emitting diode (1020). Thus, the light emitting device according to the exemplary embodiment of the present invention can have an improved brightness uniformity that is adequate to form a surface light source.

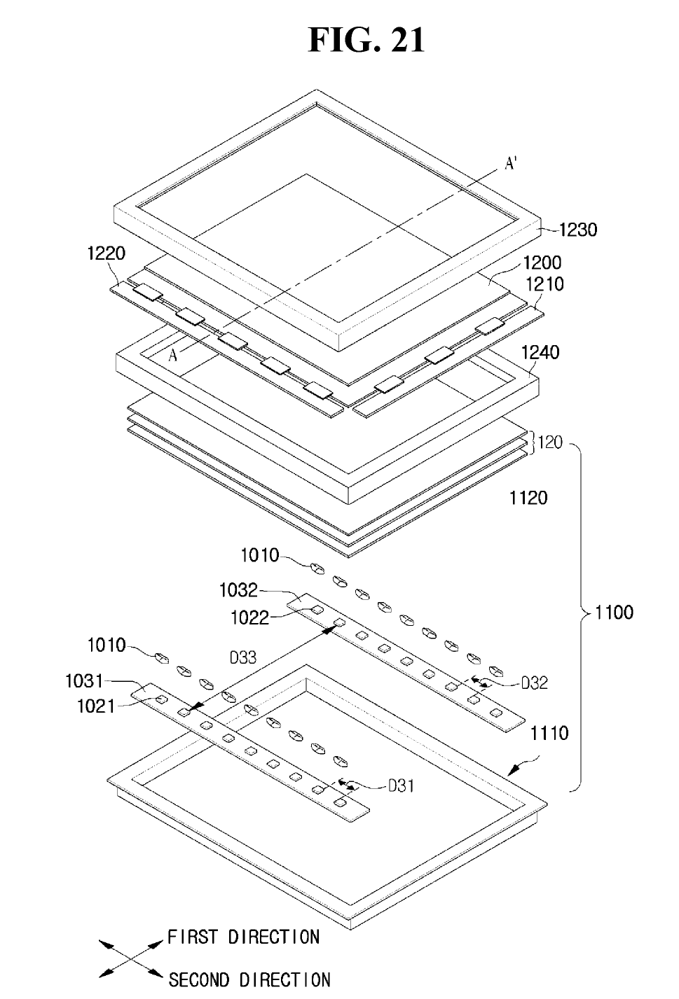

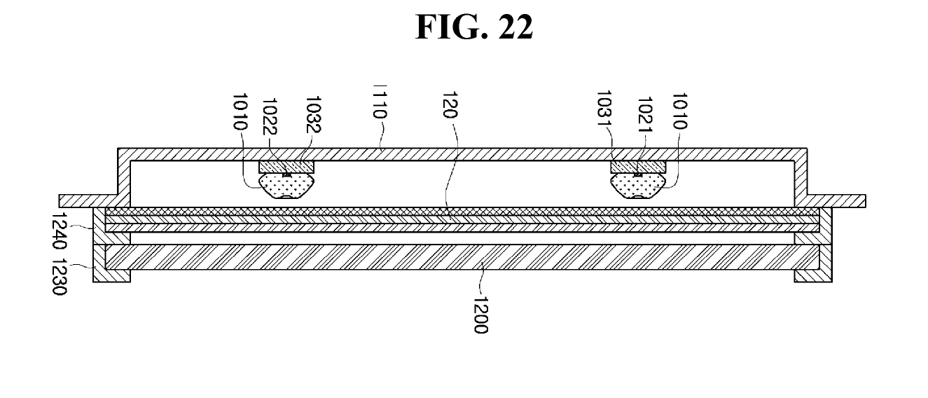

FIG. 21 is an exploded perspective view illustrating a liquid crystal display device according to a fifth exemplary embodiment of the present invention, FIG. 22 is a cross-sectional view illustrating a cross-section cut along line A-A′ of FIG. 21,

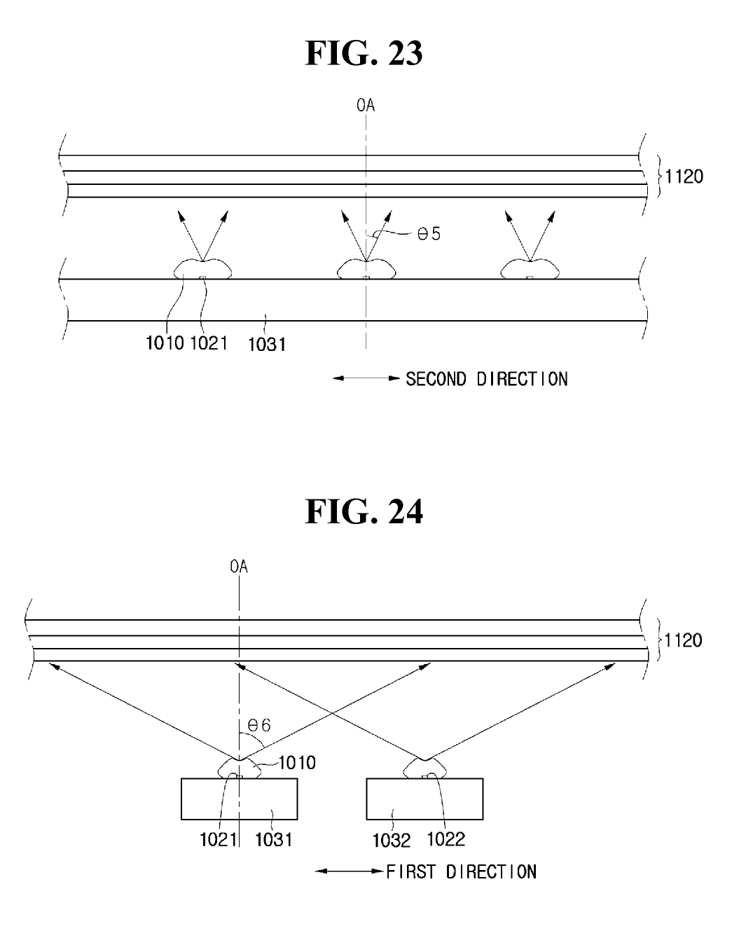

FIG. 23 is a schematic view illustrating an optical path of light emitted from a luminous flux control member based on a first direction, and FIG. 24 is a schematic view illustrating an optical path of light emitted from a luminous flux control member based on a second direction.

The present exemplary embodiment will use the light emitting device as a reference. That is, explanation and illustration of the light emitting device of the previous exemplary embodiments may be substantially combined to the present exemplary embodiment of the present invention.

Referring to FIGS. 21 to 24, a liquid crystal display device according the fifth exemplary embodiment of the present invention includes a liquid crystal display panel (1200) and a backlight unit (1100). The liquid crystal display panel (1200) displays a pictorial image.

Although not illustrated in detail, the liquid crystal display panel (1200) includes, for coherence to maintain a uniform gap by facing each other, a TFT (Thin Film Transistor) substrate, a C/F (Color Filter) substrate and a liquid crystal layer interposed between the TFT substrate and the C/F substrate. The TFT substrate is structurally configured such that a plurality of gate lines is formed, a plurality of data lines crossing the plurality of data lines is formed and TFTs are formed at a crossing area between the gate lines and the data lines.

The liquid crystal display panel (1200) includes, at an edge thereof, a gate driving PCB (Printed Circuit Board, 1210) supplying a scan signal to the gate lines, and a data driving PCB (1220) supplying a data signal to the data lines.

At this time, the gate and data driving PCBs (1210, 1220) are electrically connected to the liquid crystal display panel (1200) by a COF (Chip On Film), where the COF may be changed to a TCP (Tape Carrier Package).

Furthermore, the liquid crystal display device according the fifth exemplary embodiment of the present invention includes a panel guide (1240) supporting the liquid crystal display panel (1200), and a top case (1230) encompassing an edge of the liquid crystal display device (1200) and coupled to the panel guide (1240).

The backlight unit (1100) is mounted on a large liquid crystal display device (20-inch or more) and realized by the direct type method. The backlight unit (1100) includes a bottom cover (1110), a plurality of driving substrates (1021, 1022), a plurality of luminous flux control members (1010), and optical sheets (1120).

The bottom cover (1110) takes a shape of an upper-opened box. The bottom cover (1110) accommodates a PCB (1030). Furthermore, the bottom cover (1110) serves to support the optical sheets (1120) and the liquid crystal display panel (1200). At this time, the bottom cover (1110) may be formed with a metal. By way of non-limiting example, the bottom cover (1110) may be formed by bending or curving a metal plate. At this time, the driving substrates (1021, 1022) may be accepted into an insertion space of the bottom cover (1110) that is formed by bending or curving the metal plate.

At this time, a floor surface of the bottom cover (1110) may have a high transmissivity. That is, the floor surface itself of the bottom cover (1110) may perform a reflective sheet function. Alternatively, although not illustrated, a reflective sheet may be separately provided inside the bottom cover (1110).

The driving substrates (1021, 1022) are arranged at an inner side of the bottom cover (1110). The driving substrates (1021, 1022) may be driving substrates for driving the light emitting diodes. The PCB (1030) is electrically connected to the light emitting diodes (1021, 1022). That is, the light emitting diodes (1021, 1022) are mounted on the driving substrates (1030).

Referring to FIG. 21, each of driving substrates (1031, 1032) takes a shape extended to the first direction. To be more specific, the driving substrates (1031, 1032) may be extended to the first direction in parallel. Each of driving substrates (1031, 1032) may take a shape of a strip extended to the first direction. Two or more number of driving substrates (1031, 1032) may be provided.

Furthermore, the number of driving substrates (1031, 1032) may be determined or varied by an area of the liquid crystal display panel (1200). The driving substrates (1031, 1032) may be arranged in parallel. A length of each of the driving substrates (1031, 1032) may vary depending on width of the liquid crystal display panel (1200). At this time, each width of the driving substrates (1031, 1032) may be approximately 5 mm˜3 mm.

The driving substrates (1031, 1032) are electrically connected to the light emitting diodes (1021, 1022) and supply a driving signal to the light emitting diodes (1021, 1022). An upper surface of the driving substrates (1031, 1032) may be coated with a reflective layer for enhancing the performance of the backlight unit (1100). That is, the reflective layer may reflect upwards the light emitted from the light emitting diodes (1021, 1022).

The light emitting diodes (1021, 1022) generate light by using an electrical signal received from the driving substrates (1031, 1032). That is, the light emitting diodes (1021, 1022) are light sources generating light. To be more specific, each of the light emitting diodes (1021, 1022) is a point light source, and each of the light emitting diodes (1020) is concentrated to form a surface light source. At this time, the light emitting diodes (1021, 1022) are light emitting packages including light emitting chips.

The light emitting diodes (1021, 1022) are mounted on the driving substrates (1031, 1032). The light emitting diodes (1021, 1022) may emit white light. Alternatively, the light emitting diodes (1021, 1022) may emit blue light, green light and red light evenly.

Furthermore, the luminous flux control members are arranged on the driving substrates (1031, 1032). To be more specific, each of the luminous flux control members is arranged on each of the driving substrates (1031, 1032). The luminous flux control members can cover each of the light emitting diodes (1021, 1022). The light emitting diodes (1021, 1022) may include first light emitting diodes (1021) and second light emitting diodes (1022).

The first light emitting diodes (1021) are arranged on the first driving substrate (1031). The first light emitting diodes (1021) may be mounted on the first driving substrate (1031). To be more specific, the first light emitting diodes (1021) may be arranged in a row to the first direction. That is, the first light emitting diodes (1021) may be mounted in a row on the first driving substrate (1031). Furthermore, each of the first light emitting diodes (1021) may be distanced at a predetermined gap (D11).

The second light emitting diodes (1022) are arranged on the second driving substrate (1032). The second light emitting diodes (1022) may be mounted on the second driving substrate (1032). To be more specific, the second light emitting diodes (1022) may be arranged in a row to the first direction. That is, the second light emitting diodes (1022) may be mounted in a row on the second driving substrate (1032). Furthermore, each of the second light emitting diodes (1022) may be distanced at a predetermined gap (D22).

The first light emitting diodes (1021) may be arranged in a first row and the second light emitting diodes (1022) may be arranged in a second row, where the first and second rows may be arranged in parallel.

A gap (D31) between the first light emitting diodes (1021) is smaller than a gap (D33) between the first and second rows. By way of non-limiting example, the gap (D33) between the first and second rows may be greater than the gap (D31) between the first light emitting diodes (1021) by approximately 1.3˜10 times. To be more specific, the gap (D33) between the first and second rows may be greater than the gap (D31) between the first light emitting diodes (1021) by approximately 1.5˜3 times, or more specifically approximately 2˜2.5 times.

A gap (D32) between the second light emitting diodes (1022) is smaller than a gap (D33) between the first and second rows. By way of non-limiting example, the gap (D33) between the first and second rows may be greater than the gap (D32) between the second light emitting diodes (1022) by approximately 1.3˜10 times. To be more specific, the gap (D32) between the first and second rows may be greater than the gap (D33) between the first light emitting diodes (1021) by approximately 1.5˜3 times, or more specifically approximately 2˜2.5 times.

That is, the gaps (D32, D33) between the light emitting diodes (1021, 1022) based on the second direction are smaller than the gaps (D33) between the light emitting diodes (1021, 1022) based on the first direction. That is, the light emitting diodes (1021, 1022) may be more densely arranged based on the second direction, and the light emitting diodes (1021, 1022) may be less densely arranged based on the first direction.

At this time, as illustrated in FIG. 23, although the light emitting diodes (1021, 1022) may be more densely arranged toward the second direction, the luminous flux control member (1010) may diffuse light less to the second direction than to the first direction. That is, the luminous flux control member (1010) may emit light from the light emitting diodes (1021, 1022) with a relatively smaller beam spread angle.

At this time, as illustrated in FIG. 24, although the light emitting diodes (1021, 1022) may be less densely arranged toward the first direction, the luminous flux control member (1010) may diffuse light more to the first direction than to the second direction. That is, the luminous flux control member (1010) may emit light from the light emitting diodes (1021, 1022) with a relatively greater beam spread angle.

The optical sheets (1120) are arranged on the light emitting diodes (1021, 1022). The optical sheets (1120) may be arranged on the bottom cover (1110). The optical sheets (1120) may cover the light emitting diodes (1021, 1022).

The optical sheets (1120) may enhance optical characteristics of passing light. The optical sheets (1120) may include a diffusion sheet, a first prism sheet and a second prism sheet.

The diffusion sheet is arranged on the light emitting diodes (1021, 1022). The diffusion sheet covers the light emitting diodes (1021, 1022). To be more specific, the diffusion sheet can cover an entire area of the light emitting diodes (1021, 1022).

The light emitted from the light emitting diodes (1021, 1022) is incident on the diffusion sheet. The light from the light emitting diodes (1021, 1022) may be diffused by the diffusion sheet.

The first prism sheet is arranged on the diffusion sheet. The first prism sheet may include a pattern having a pyramid shape. The first prism sheet may enhance straightness of light from the diffusion sheet.

The second prism sheet is arranged on the first prism sheet. The second prism sheet may include a pattern having a pyramid shape. The second prism sheet may further enhance straightness of light from the first prism sheet.

As apparent from the foregoing, the liquid crystal display device according to the fifth exemplary embodiment of the present invention can diffuse light emitted from the light emitting diodes (1021, 1022) more to the first direction than to the second direction, using the luminous flux control member. At this time, the liquid crystal display device according to the fifth exemplary embodiment of the present invention arranges the light emitting diodes (1021, 1022) more densely to the second direction, and arranges the light emitting diodes (1021, 1022) less densely to the first direction.

As a result, the liquid crystal display device according to the fifth exemplary embodiment of the present invention can reduce the number of rows of the light emitting diodes (1021, 1022). That is, the liquid crystal display device according to the fifth exemplary embodiment of the present invention arranges the light emitting diodes (1021, 1022) anisotropically instead of arranging the light emitting diodes (1021, 1022) at an equidistance, regardless of directions.

Lack of brightness uniformity that may be generated by the anisotropic arrangement of the light emitting diodes (1021, 1022) may be compensated by anisotropical optical diffusion by the luminous flux control member (1010), whereby the liquid crystal display device according to the fifth exemplary embodiment of the present invention can have brightness uniformity on the whole. That is, the light having passed the luminous flux control member (1010) is incident on the liquid crystal display panel (1200) with a uniform brightness as a whole.

That is, the liquid crystal display device according to the fifth exemplary embodiment of the present invention can have high brightness uniformity as a whole using the luminous flux control members (1010), even if the number of rows of the light emitting diodes (1021, 1022) is reduced. That is, even if a gap between the light emitting diodes (1021, 1022) is broadened, the brightness uniformity can be enhanced by the luminous flux control members (1010).

While the present invention has been described with respect to the above exemplary embodiments, the present invention is not so limited and should be understood to be merely exemplary. Various modifications to the invention will be readily apparent to those skilled in the art, and the generic principles defined herein may be applied to other variations without departing from the spirit or scope of the invention. For example, each constituent element explained in detail in the above exemplary embodiments may be implemented in other various modifications.

### INDUSTRIAL APPLICABILITY

The exemplary embodiments of the present invention has an industrial applicability by providing a luminous flux control member, a display device and a light emitting device capable of expanding coverage (range) of optical wavelength on a display panel by emitting, by the luminous flux control member, light to a bottom surface of a plane perpendicular to an optical axis of light source.

1. A member for controlling luminous flux (“luminous flux control member”), the member comprising: an incident surface receiving light; a reflective surface reflecting the incident light; and a light emitting surface emitting the reflected light to a bottom surface of a plane perpendicular to a central axis connecting a center of the incident surface and a center of the reflective surface.

2. The luminous flux control member of claim 1, wherein a first direction perpendicular to the central axis, and a second direction perpendicular to the central axis and crossing the first direction are defined, and a first length based on the first direction is shorter than a second length based on the second direction.

3. The luminous flux control member of claim 2, wherein the first and second directions are orthogonal.

4. The luminous flux control member of claim 2, wherein the reflective surface is an inner surface of a depression unit formed opposite to the incident surface.

5. The luminous flux control member of claim 4, wherein the depression unit is configured such that a third length based on the first direction is shorter than a fourth length based on the second direction.

6. A member for controlling luminous flux (“luminous flux control member”), the member comprising: an incident surface receiving light; and a refractive surface emitting the light from the incident surface, wherein a central axis is defined as being extended from a center of the incident surface to a center of the refractive surface, a first direction is defined as passing the central axis, being perpendicular to the central axis, and crossing the first direction, and a second direction is defined as passing the central axis, being perpendicular to the central axis and orthogonal to the first direction, wherein a shape of the refractive surface based on the first direction is different from a shape of the refractive surface based on the second direction.

7. The luminous flux control member of claim 6, wherein the first direction is orthogonal to the second direction.

8. The luminous flux control member of claim 6, further comprising a rear surface extended from the incident surface to the refractive surface, wherein a first distance from the central axis to a portion where the refractive surface and the rear surface meet based on the first direction is shorter than a second distance from the central axis to a portion where the refractive surface and the rear surface meet based on the second direction.

9. The luminous flux control member of claim 6, satisfying the following Equations 1 and 2:
θ5x/θ1x=ax>1 [Equation 1]
θ5y/θ1y=ay>1 [Equation 2]
where, θ1x is an angle formed between an arbitrary light incident through the incident surface and the central axis based on the first direction, θ5x is an angle formed between light emitted through a light emitting surface and the central axis, in a case light incident at the angle of θ1x is emitted through the light emitting surface based on the first direction, θ1y is an angle formed between an arbitrary light incident through the incident surface and the central axis based on the second direction, and θ5y is an angle formed between light emitted through the light emitting surface and the central axis, in a case light incident at the angle of θ1y is emitted through the light emitting surface based on the second direction, where ax is different from ay.

10. The luminous flux control member of claim 9, wherein ax decreases in a case θ1x increases, and ay decreases in a case θ1y increases.

11. The luminous flux control member of claim 10, further comprising a rear surface extended from the incident surface to the refractive surface, wherein the refractive surface includes a first refractive surface extended from the rear surface, and a distance between the first refractive surface and the central axis tapers off as being distanced from the rear surface based on the first direction.

12. The luminous flux control member of claim 11, further comprising a depression unit opposite to the incident surface.

13. A light emitting device, the device comprising: a driving substrate; a light source arranged on the driving substrate; a luminous flux control member arranged on the light source and including an incident surface incident with light generated from the light source, a reflective surface reflecting the incident light, and a light emitting surface emitting the reflected light to a bottom surface of a plane perpendicular to a central axis connecting a center of the incident surface to a center of the reflective surface.

14. The light emitting device of claim 13, further comprising a reflective unit arranged on the driving substrate for reflecting the emitted light.

15. The light emitting device of claim 14, wherein the reflective unit reflects the emitted light in a lambertian type.

16. The light emitting device of claim 14, wherein the luminous flux control member is such that a first direction perpendicular to the central axis, and a second direction perpendicular to the central axis and crossing the first direction are defined, and a first length based on the first direction is shorter than a second length based on the second direction.

17. The light emitting device of claim 16, wherein the luminous flux control member emits the reflected light to a bottom surface of the plane based on the first direction.

18. The light emitting device of claim 16, wherein the reflective unit is distanced from the luminous flux control member to the first direction, and extended to the second direction.

19. A display device, the device comprising: a driving substrate; a light source arranged on the driving substrate; a luminous flux control member arranged on the light source and including an incident surface incident with light generated from the light source, a reflective surface reflecting the incident light, and a light emitting surface emitting the reflected light to a bottom surface of a plane perpendicular to a central axis connecting a center of the incident surface to a center of the reflective surface; and a display panel incident with the emitted light.

20. The display device of claim 19, further comprising; a cover accommodating the driving substrate; and a reflective unit arranged on any one of the driving substrate and the cover to reflect the emitted light.

21. The display device of claim 20, wherein the reflective unit reflects the emitted light in a lambertian type.

22. The display device of claim 20, wherein the luminous flux control member is such that a first direction perpendicular to the central axis, and a second direction perpendicular to the central axis and crossing the first direction are defined, and a first length based on the first direction is shorter than a second length based on the second direction.

23. The display device of claim 22, wherein the luminous flux control member emits the reflected light to a bottom surface of the plane based on the first direction.

24. The display device of claim 22, wherein the reflective unit is distanced from the luminous flux control member to the first direction, and extended to the second direction.

25. A display device, the device comprising: a driving substrate extended to a second direction; a light source arranged on the driving substrate; a luminous flux control member arranged on the driving substrate to cover the light source; and a display panel incident with light from the luminous flux control member, wherein the luminous flux control member includes a refractive surface emitting the light from the light source, and the luminous flux control member is such that a first direction is defined as passing an OA (Optical Axis) of the light source, being perpendicular to the OA, and orthogonal to a second direction, wherein a shape of the refractive surface based on the first direction is different from a shape of the refractive surface based on the second direction.

26. The display device of claim 25, wherein the luminous flux control member satisfies the following Equations 1 and 2:
θ5x/θ1x=ax>1 [Equation 1]
θ5y/θ1y=ay>1 [Equation 2]
where, θ1x is an angle formed between an arbitrary light incident through the incident surface and the central axis based on the first direction, θ5x is an angle formed between light emitted through a light emitting surface and the central axis, in a case light incident at the angle of θ1x is emitted through the light emitting surface based on the first direction, θ1y is an angle formed between an arbitrary light incident through the incident surface and the central axis based on the second direction, and θ5y is an angle formed between light emitted through the light emitting surface and the central axis, in a case light incident at the angle of θ1y is emitted through the light emitting surface based on the second direction, where ax is different from ay.

27. The display device of claim 25, wherein the light incident from the light source and emitted through the refractive surface has a first beam angle based on the first direction, and has a second beam angle based on the second direction, wherein the first beam angle is greater than the second beam angle.
